(19) United States
(12) Patent Application Publication
(10) Pub. No.: US 2025/0053832 A1
(43) Pub. Date: Feb. 13, 2025

(54) Systems, Methods and Apparatus for Machine Learning Predictive Analytics

(71) Applicant: Ryan Newsome, Monroe, OH (US)

(72) Inventor: Ryan Newsome, Monroe, OH (US)

(21) Appl. No.: 18/448,966

(22) Filed: Aug. 13, 2023

(51) Int. Cl. G06N 5/022

(52) U.S. Cl. CPC G06N 5/022

(57) ABSTRACT

Systems, methods and apparatus of machine-learning-predictive-analytics, the method performed by a predictive analytic control computer and including receiving from a second computer a training-profile data that describes one or more contributions of resources that are associated and identified with particular entities, receiving from a third computer a training-profile data that are associated and identified with the particular entities, that does not describe one or more contributions of resources the training-profile data, and that includes data that is that is received from additional computers that host websites and applications that focus on communication, community-based input, interaction, content-sharing and collaboration that describe a first set of features and representations of issues of interest of the particular entities, generating a machine-learning-predictive-analytic model by a machine learning-predictive-analytic trainer in reference to the training-profile data, generating predictions from the machine-learning-predictive-analytic model and from a second set of features and representations of issues of interest.

### FIELD OF THE INVENTION

This disclosure relates generally to machine learning, and more particularly to machine learning predictive analytics.

### BACKGROUND OF THE INVENTION

Conventional analysis systems perform very little, if any predictive analysis, of past patterns of actions in order to predict future actions. In particular, manual predictions of contributions of resources that other entities will make in regards to particular issues tend to be very inaccurate. Examples of resources include computing cycles, computing timesharing time and data storage.

### SUMMARY OF THE INVENTION

The above-mentioned shortcomings, disadvantages and problems are addressed herein, which will be understood by reading and studying the following specification.

In one aspect, systems, methods and apparatus provide a method of machine learning predictive analytics, the method performed by a predictive analytic control computer (a first computer) and including receiving from a second computer a plurality of training profile data that describes one or more contributions of resources that are associated and identified with particular entities, receiving from a third computer a plurality of training profile data that are associated and identified with the particular entities, that does not describe one or more contributions of resources the training profile data, and that includes data that is that is received from additional computers that host websites and applications that focus on communication, community-based input, interaction, content-sharing and collaboration that describe features and representations of issues of interest of the particular entities, generating a machine learning predictive analytic model by a machine learning predictive analytic trainer in reference to the training profile data, generating a plurality of predictions from the machine learning predictive analytic model and new data, and transmitting the plurality of predictions to a memory.

In another aspect, a method of generating and storing a plurality of predictions, the method includes training a machine learning predictive analytic engine in reference to training profile data, receiving from a memory a new data, generating the plurality of predictions by the machine learning predictive analytic engine in reference to new data and a machine learning predictive analytic model, and storing the plurality of predictions to the memory.

In another aspect, a system is operable to perform machine learning predictive analytics of new data by a machine learning predictive analytic engine on a predictive analytic control computer, in which the predictive analytic control computer is a first computer and in which a second computer is operable to transmit to the first computer a first training profile data, the first training profile data being associated and identified with an entity from websites and applications that focus on communication, community-based input, interaction, content-sharing and collaboration that describe features and representations of issues of interest of the entity, the first computer being operable to transmit the first training profile data being to a memory, the system further including a third computer that transmits to the memory of the first computer a second training profile data, the second training profile data being descriptive of one or more contributions of resources that is/are associated and identified with particular entities, the first computer being operable to store the first training profile data and the second training profile data in a profile data file and the first computer being operable to transmit the profile data file to a learning predictive analytic trainer that is operable to produce a machine learning trained model from the profile data file, the machine learning predictive analytic engine in the first computer being operable to parameter receive a parameter, and the machine learning predictive analytic engine being operable to generate a prediction in reference to the machine learning trained model and the parameter, and the first computer being operable to store the prediction to memory.

The machine learning models can be trained in one of four different general approaches: supervised training that is task driven to predict the next value that uses mapping between input and output, where the feedback provided to the agent is a correct set of actions for performing a task, and in which processes learn from labeled data using the supervised learning method in machine learning, which involves the process receiving input data and the appropriate output labels; the goal of which is to teach the process to correctly predict labels for brand-new, untainted data, examples of which include processes like decision trees, support vector machines, random forests, and naive bayes, which can be applied to classification, regression, and time series forecasting tasks, in order to make predictions and derive useful insights from data; unsupervised training that is data driven in order to identify clusters of data that have commonalities by automatically finding patterns and relationships in the dataset with no prior knowledge of the dataset or no prior training on the dataset, in which processes analyze unlabeled data in this machine learning method without using predetermined output labels, and finding patterns, relationships, or structures within the data is the aim, in contrast to supervised learning, unsupervised training operates autonomously to unearth secret information and combine related data points, including clustering processes like K-means, hierarchical clustering, and DBSCAN, as well as dimensionality reduction techniques like PCA and t-SNE. Semi-supervised learning is a hybrid approach to machine learning that uses both labeled and unlabeled data for training, in order to enhance learning, makes use of both a larger set of unlabeled data and a smaller amount of labeled data, in which the unlabeled data are supposed to offer extra context and information to improve the model's comprehension and functionality, and which can get around the drawbacks of only using labeled data by effectively utilizing the unlabeled data, and that is especially helpful when getting labeled data requires a lot of resources or processing power. Reinforcement-based learning is which a machine learning process called reinforcement learning is developed in part as a reference to how people learn by making mistakes, in which an agent interacts with the environment and learns to choose the best course of action to maximize cumulative rewards. Based on its actions, the agent receives feedback in the form of rewards or penalties and over time, the agent develops the ability to make decisions that produce the best results, which makes it possible for machines to use a series of actions to accomplish long-term objectives, adapt to changing environments, and learn from their experiences, and that is an effective method for addressing challenging decision-making issues thanks to its dynamic learning approach. Reinforcement-based learning uses mapping between input and output and uses rewards and punishments as signals for positive and negative behavior. Furthermore, a Decision Tree process is a supervised learning process that is used for problem classification and categorizing both categorical and continuous dependent variables, which the population is split into two or more homogeneous sets using this process, depending on the most important features or independent variables. Gradient boosting process and AdaBoosting processes are used when massive loads of data have to be handled to make predictions with high accuracy and is an ensemble learning algorithm that combines the predictive power of several base estimators to improve robustness, which combines multiple weak or average predictors to build a strong predictor. K-Means process manages clustering issues by using unsupervised learning, in which data sets are divided into a certain number of clusters (e.g. number K) in such a way that all the data points within a cluster are homogenous and heterogeneous from the data in other clusters, in which clusters can be created in the following ways: The K-means process selects k centroids, or points, for each cluster, with the closest centroids, each data point creates a cluster, i.e. clusters of K. From the current cluster members, then generates new centroids, the closest distance for every data point is calculated using these new centroids, p until the centroids stay the same, this process is repeated. KNN (K-Nearest Neighbors) process, in which both classification and regression issues can be solved using this process, a process that classifies any new cases by obtaining a majority vote from its k neighbors and then stores all of the existing cases, the class with which the case has the most in common is then given the assignment, this calculation is made using a distance function and the following factors should be taken into account before choosing the K Nearest Neighbors process, and normalizing variables is necessary to prevent process bias from higher range variable, and processing of the prior data is still required. Linear regression process in which fitting the independent and dependent variables to a line, a relationship between them can be found in this process. Logistic Regression in which discrete values (typically binary values like 0/1) are estimated from a set of independent variables using logistic regression and by adjusting the data to a logic function, it aids in predicting the likelihood of an event. Additionally known as logic regression. The Naive Bayes process in which an assumption made by a Naive Bayes classifier is that the presence of one feature in a class has no bearing on the presence of any other features, then when determining the likelihood of a specific result, a Naive Bayes classifier takes into account each of these features independently, even if these features are related to one another, large datasets can benefit from using a Naive Bayesian model. Random Forests Process in which an arrangement of decision trees, wherein each tree is assigned a class and “votes” for that class in order to categorize a new object according to its attributes, and over all of the trees in the forest, the classification with the most votes is chosen by the forest. The SVM process (Support Vector Machine) which plots raw data as points in an n-dimensional space (where n is the number of features), such as a classification process, thereafter, each feature's value is associated with a specific coordinate, which facilitates the data's classification, and the data can be divided into groups and plotted on a graph using lines known as classifiers.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF DRAWINGS

FIG. 1 is a block diagram of an overview of a system that is operable to perform machine learning predictive analytics by a machine learning predictive analytic engine, according to an implementation.

FIG. 2 is a block diagram of an apparatus that is operable to perform machine learning predictive analytics of new data by a machine learning predictive analytic engine, according to an implementation.

FIG. 3 is a block diagram of an apparatus that is operable to perform machine learning predictive analytics of new data by a machine learning predictive analytic engine on a predictive analytic control computer, according to an implementation.

FIG. 4 is a block diagram of an apparatus that is operable to perform machine learning predictive analytics of data that describes features and representations of issues of interest of the entities, at least some of which are in common with other training profile data, by a machine learning predictive analytic engine on a predictive analytic control computer, according to an implementation.

FIG. 5 is a block diagram of an apparatus that is operable to perform machine learning predictive analytics of data that describes features and representations of issues of interest of the entities, none of which are in common with other training profile data, by a machine learning predictive analytic engine on a predictive analytic control computer, according to an implementation.

FIG. 6 is a block diagram of an apparatus that is operable to perform machine learning predictive analytics of data that describes features but not representations of issues of interest of the entities, at least some of which are in common with other training profile data, by a machine learning predictive analytic engine on a predictive analytic control computer, according to an implementation.

FIG. 7 is a block diagram of an apparatus that is operable to perform machine learning predictive analytics of data that describes features but not representations of issues of interest of the entities, none of which are in common with other training profile data, by a machine learning predictive analytic engine on a predictive analytic control computer, according to an implementation.

FIG. 8 is a block diagram of an apparatus that is operable to perform machine learning predictive analytics of data that describes representations of issues of interest but not features of the entities, at least some of which are in common with other training profile data, by a machine learning predictive analytic engine on a predictive analytic control computer, according to an implementation.

FIG. 9 is a block diagram of an apparatus that is operable to perform machine learning predictive analytics of data that describes representations of issues of interest but not features of the entities, none of which are in common with other training profile data, by a machine learning predictive analytic engine on a predictive analytic control computer, according to an implementation.

FIG. 10 is a block diagram of a predictive analytic control computer that is operable to perform machine learning predictive analytics to determine a magnitude of a contribution of resources by an entity in reference to a keyword, according to an implementation.

FIG. 11 is a block diagram of a trainer in a predictive analytic control computer that is operable to train a machine learning model to produce a first set of quantitative measures representing a set of quantitative measures representing previous activity of the contribution of the resources of the plurality of entities or train a machine learning model to produce a second set of quantitative measures representing a set of second predicted contribution growth, according to an implementation.

FIG. 12A and FIG. 12B are block diagrams of a trainer in a predictive analytic control computer, according to an implementation that performs machine learning predictive analytics to determine a magnitude of a contribution of resources by an entity in reference to a keyword, the trainer being in a microprocessor in a predictive analytic control computer, according to an implementation.

FIG. 13 is a block diagram of an apparatus that is operable to perform machine learning predictive analytics to determine a magnitude of a contribution of resources by an entity in reference to a keyword, the apparatus is implemented in a microprocessor in a predictive analytic control computer, according to an implementation.

FIG. 14 is a block diagram of an apparatus that is operable to perform machine learning predictive analytics to generate communications to contributors, according to an implementation.

FIG. 15 is a block diagram of an apparatus that is operable to perform machine learning predictive analytics to generate communications to contributors, according to an implementation.

FIG. 16 is a block diagram of an apparatus of generating a machine learning model from the associated data and generating communications to the contributor from the machine learning model, according to an implementation.

FIG. 17 is a flowchart of a method of generating and storing a prediction, according to an implementation.

FIG. 18 is a flowchart of a method of generating and storing a prediction, according to an implementation of FIG. 1 and FIG. 2.

FIG. 19 is a flowchart of a method of generating and storing a prediction according to an implementation of FIG. 3 in reference to new data and from training data that describes one or more contributions of resources and from training data that describes features and representations of issues of interest of the entities.

FIG. 20 is a flowchart of a method of generating and storing a prediction according to an implementation of FIG. 4 in reference to new data and from training data that describes features and representations of issues of interest of the entities that are in common with training data that describes one or more contributions of resources.

FIG. 21 is a flowchart of a method of generating and storing a prediction according to an implementation of FIG. 5 in reference to new data and from training data that describes features and representations of issues of interest of the entities that are not in common with training data that describes one or more contributions of resources.

FIG. 22 is a flowchart of a method of generating and storing a prediction according to an implementation of FIG. 6 in reference to new data and from training data that describes features of the entities that are in common with training data that describes one or more contributions of resources.

FIG. 23 is a flowchart of a method of generating and storing a prediction according to an implementation of FIG. 7 in reference to new data and from training data that describes features of the entities that are not in common with training data that describes one or more contributions of resources.

FIG. 24 is a flowchart of a method of generating and storing a prediction according to an implementation of FIG. 8 in reference to new data and from training data that describes representations of issues of interest of the entities that are in common with training data that describes one or more contributions of resources.

FIG. 25 is a flowchart of a method of generating and storing a prediction according to an implementation of FIG. 9 in reference to new data and from training data that describes representations of issues of interest of the entities that are not in common with training data that describes one or more contributions of resources.

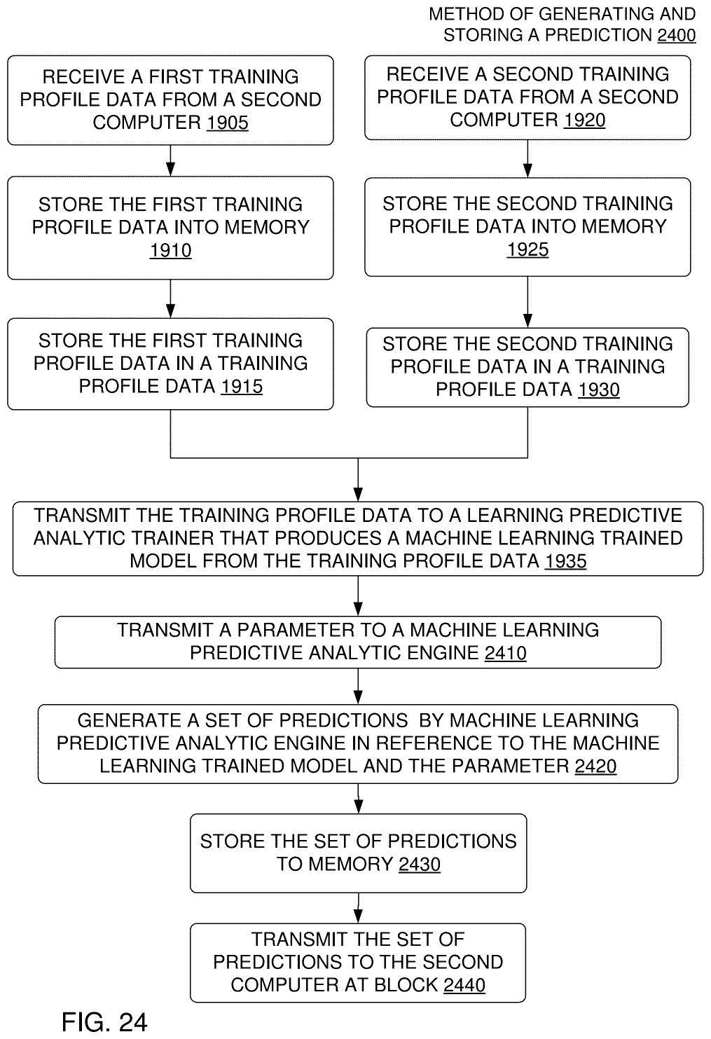

FIG. 24 is a flowchart of a method of machine learning predictive analytics to determine a magnitude of a contribution of resources by an entity in reference to a keyword, the method performed by a microprocessor in a predictive analytic control computer.

FIG. 26 is a flowchart of a method of machine learning predictive analytics to determine a magnitude of a contribution of resources by an entity in reference to a keyword, the method performed by a microprocessor in a predictive analytic control computer.

FIG. 28 is a flowchart of a method of machine learning predictive analytics to determine a magnitude of a contribution of resources by an entity in reference to a keyword, the method performed by a microprocessor in a predictive analytic control computer.

FIG. 29 is a flowchart of a method of machine learning predictive analytics to determine a magnitude of a contribution of resources by an entity in reference to a keyword, the method performed by a microprocessor in a predictive analytic control computer, according to an implementation.

FIG. 30 is a flowchart of a method of machine learning predictive analytics to determine a magnitude of a contribution of resources by an entity in reference to a keyword, the method performed by a microprocessor in a predictive analytic control computer, according to an implementation.

FIG. 31 is a flow chart of a method of machine learning predictive analytics to generate communications to contributors, according to an implementation.

FIG. 32 is a flow chart of a method of machine learning predictive analytics to generate communications to contributors, according to an implementation.

FIG. 33 is a flowchart of a method of generating a machine learning model from the associated data and generating communications to the contributor from the machine learning model, according to an implementation.

FIG. 34 is a block diagram of a predictive analytic control computer, according to an implementation.

FIG. 35 is a block diagram of a data acquisition circuit of a predictive analytic control computer, according to an implementation.

FIG. 36 is a block diagram of a hardware and operating environment in which different implementations can be practiced.

FIG. 37 is a block diagram of a predictive analytic control mobile device, according to an implementation.

### DETAILED DESCRIPTION OF THE INVENTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, apparatus of implementations are described. In the third section, implementations of methods are described. In the fourth section, machine learning processes are described, in the fifth section, a hardware and the operating environment in conjunction with which implementations may be practiced are described. Finally, in the fifth section, a conclusion of the detailed description is provided.

### System Level Overview

The system level overview of the operation of an implementation is described in this section of the detailed description.

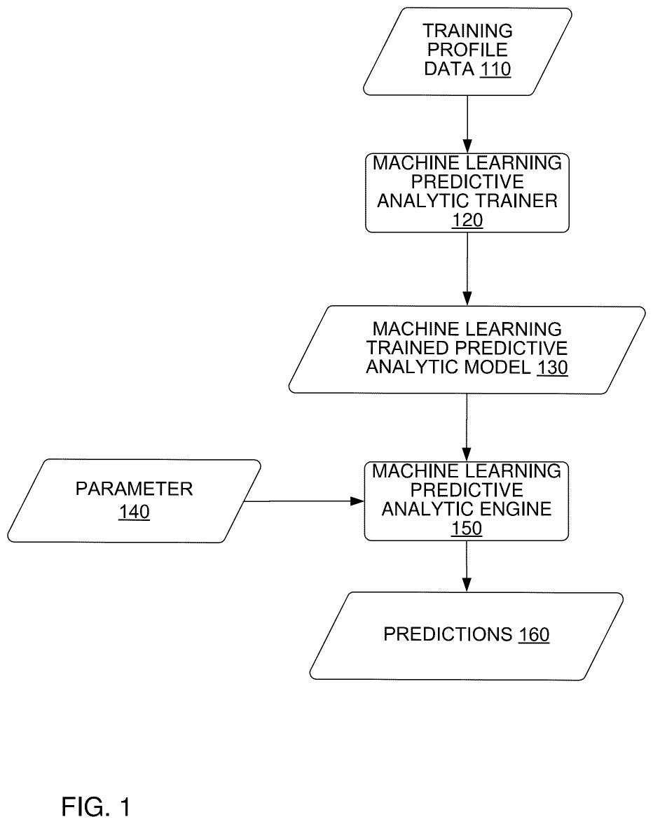

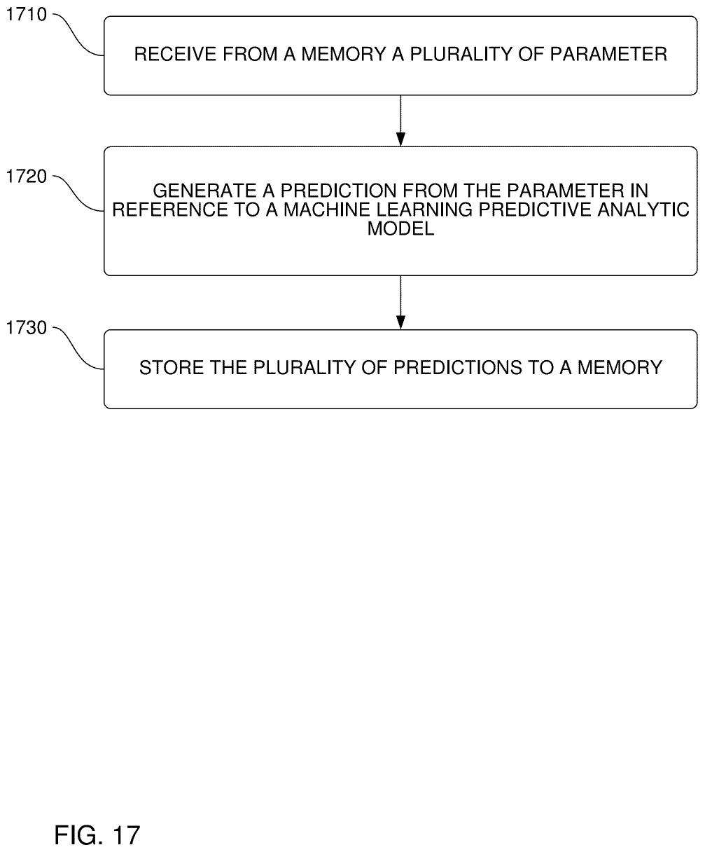

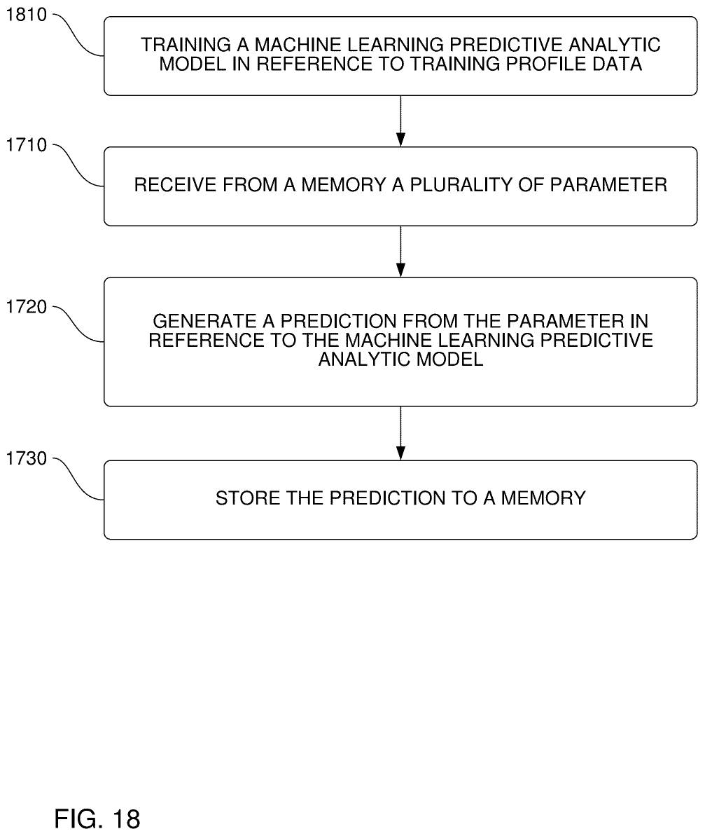

FIG. 1 is a block diagram of an overview of a system 100 of predictive analytics by a machine learning predictive analytic engine, according to an implementation. System 100 generates predictions accordingly. In some implementations, system 100 performs method 1700 in FIG. 17 or method 1800 in FIG. 18.

System 100 includes training profile data 110 that is received by a machine learning predictive analytic trainer 120 that produces a machine learning trained model 130 from the training profile data 110. In some implementations, the training profile data 110 includes data describing one or more contributions of resources that is/are associated and identified with particular entities. The training profile data 110 includes data that is associated and identified with the same particular entities from websites and applications that focus on communication, community-based input, interaction, content-sharing and collaboration that describe the features and representations of issues of interest of the entities. The representations of issues of interest can be independent or decoupled, or the representations of issues of interest can be dependent and coupled. The entities include organizations, such as businesses and trusts, and also individuals. In some implementations, the entities only include individuals. The features are characteristics (subjective or objective) or measurable properties of the entities. In some implementations, the characteristics are independent from each other, in other implementations, the characteristics are dependent on each other.

The parameter 140 is transmitted to the machine learning predictive analytic engine 150, and the machine learning predictive analytic engine 150 generates the prediction 160 in reference to the machine learning trained model 130 and the parameter 140.

In some implementations, system 100 performs the functions described herein recursively to generate improved predictions by the machine learning predictive analytic engine 150 in reference to the parameter 140.

While the system 100 is not limited to any particular training profile data 110, machine learning predictive analytic trainer 120, machine learning trained model 130, parameter 140, machine learning predictive analytic engine 150, prediction 160 and plurality of entities, but for the sake of clarity a simplified training profile data 110, machine learning predictive analytic trainer 120, machine learning trained model 130, parameter 140, machine learning predictive analytic engine 150, prediction 160 and plurality of entities are described.

### Apparatus Implementations

In the previous section, a system level overview of the operation of an implementation was described. In this section, the particular apparatus of such an implementation are described by reference to a series of diagrams.

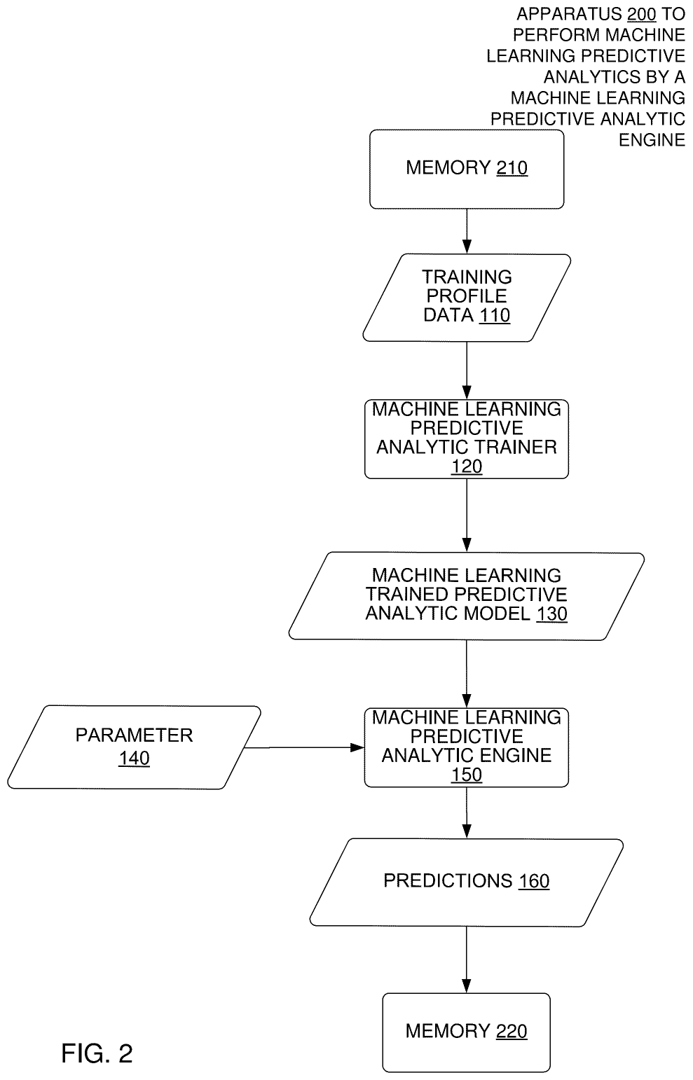

FIG. 2 is a block diagram of an apparatus that is operable to perform machine learning predictive analytics 200 of new data by a machine learning predictive analytic engine, according to an implementation.

Apparatus 200 includes a memory 210 from which the training profile data 110 is stored or transmitted to the learning predictive analytic trainer 120 that produces a machine learning trained model 130 from the training profile data 110. In some implementations, the training profile data 110 includes data describing one or more contributions of resources that is/are associated and identified with particular entities. The training profile data 110 includes data that is associated and identified with the same particular entities from websites and applications that focus on communication, community-based input, interaction, content-sharing and collaboration that describe the features and representations of issues of interest of the entities. The entities include organizations, such as businesses and trusts, and also individuals. In some implementations, the entities only include individuals.

The parameter 140 is transmitted to the machine learning predictive analytic engine 150, and the machine learning predictive analytic engine 150 generates the prediction 160 in reference to the machine learning trained model 130 and the parameter 140, and stored to a memory 220. In some implementations, a memory that stores the machine learning predictive analytic engine 150, the parameter 140, the memory 210 and the memory 220 are all the same memory, such as SDRAM 3406 in FIG. 34, mass storage 3612 in FIG. 36, RAM 3708 and memory 3710 in FIG. 37. The machine learning predictive analytic engine 150 can be implemented as a machine learning linear regression engine, a machine learning logistic regression engine, a machine learning decision tree engine, a machine learning SVM engine, a machine learning Naive Bayes engine, a machine learning KNN engine, a machine learning linear K-means engine, a machine learning random forest engine, a machine learning dimensionality reduction engine, a machine learning gradient boosting engine or a machine learning ADA boosting engine. A machine learning predictive analytic engine 150 can be implemented as hardware and/or as a sequence of instructions which, when executed by a processor, (such as processor 3402 in FIG. 34, processing unit 3604 in FIG. 36 and main processor 3702 in FIG. 37), cause the processor to perform the respective function described below in the section “Machine Learning Processes”. The machine learning predictive analytic engine 150 can be a core component of a larger complex system of components, all of which have defined interfaces and dependencies.

The parameter 140 can include, but is not limited to documents (such as text data), voice recordings, video conference recordings and email stored on the server(s) of one of the entities. In some implementations, apparatus 200 performs the functions described in FIG. 2 recursively to generate improved predictions by the machine learning predictive analytic engine 150 in reference to the parameter 140.

Examples of the websites and applications that focus on communication, community-based input, interaction, content-sharing and collaboration that describe the features and representations of issues of interest of the entities in the training profile data 110 include www.facebook.com, www.instagram.com, www.disqus.com, and www.twitter.com.

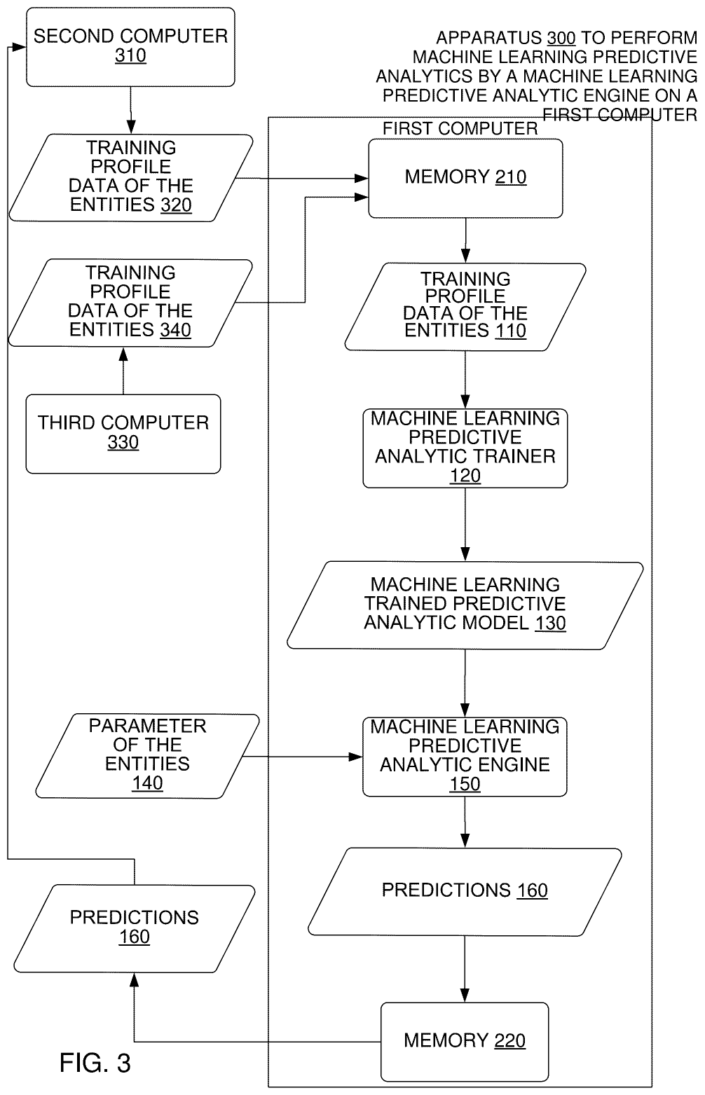

FIG. 3 is a block diagram of an apparatus that is operable to perform machine learning predictive analytics 300 of new data by a machine learning predictive analytic engine on a predictive analytic control computer, according to an implementation. In some implementations, apparatus 300 performs method 1900. The predictive analytic control computer is a first computer in apparatus 300.

Apparatus 300 includes a second computer 310 that transmits to the memory 210 training profile data 320. In some implementations, the training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 300 includes a third computer 330 that transmits to the memory 210 training profile data 340. In some implementations, the training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The parameter 140 is transmitted to the machine learning predictive analytic engine 150, and the machine learning predictive analytic engine 150 generates the predictions 160 in reference to the machine learning trained model 130 and the parameter 140, and stored to a memory 220. In some implementations, the predictions 160 are transmitted to the second computer 310.

In some implementations of the apparatus 300 in FIG. 3 the predictions are predictive analytics of future contributions of resources of the particular entities and the

In some implementations of the apparatus 300 in FIG. 3 the parameter is a second set of features and representations of issues of interest.

The machine learning predictive analytic apparatus 300 of FIG. 3 is highly accurate at generating predictive analytics of future contributions of resources of the particular entities.

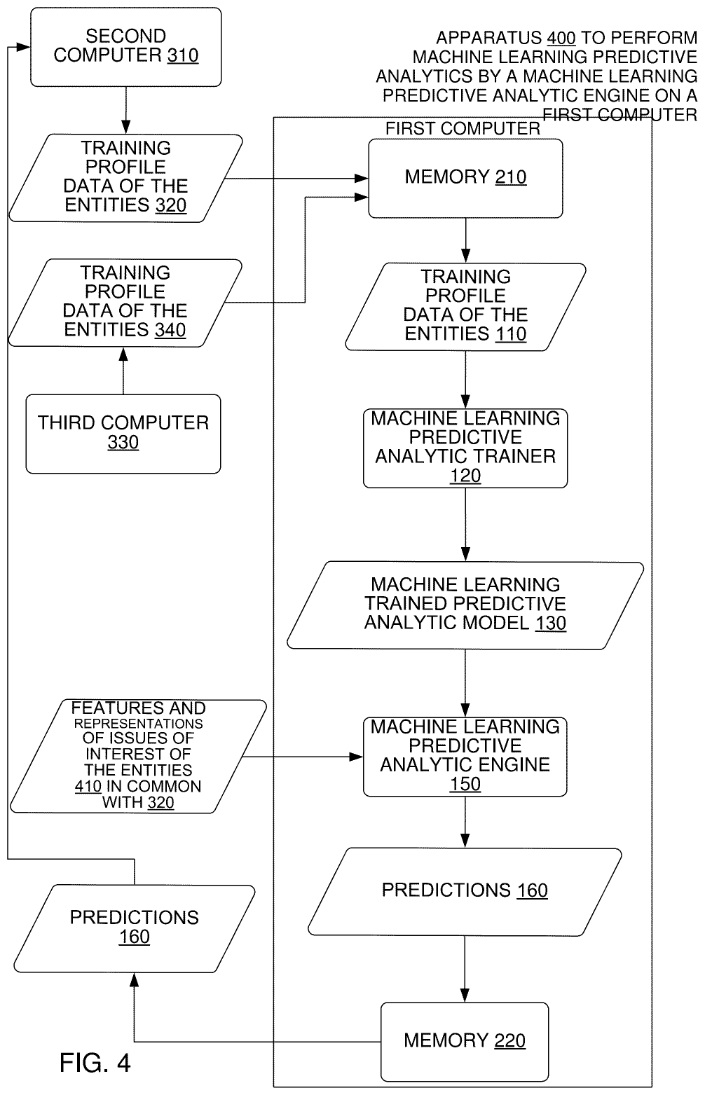

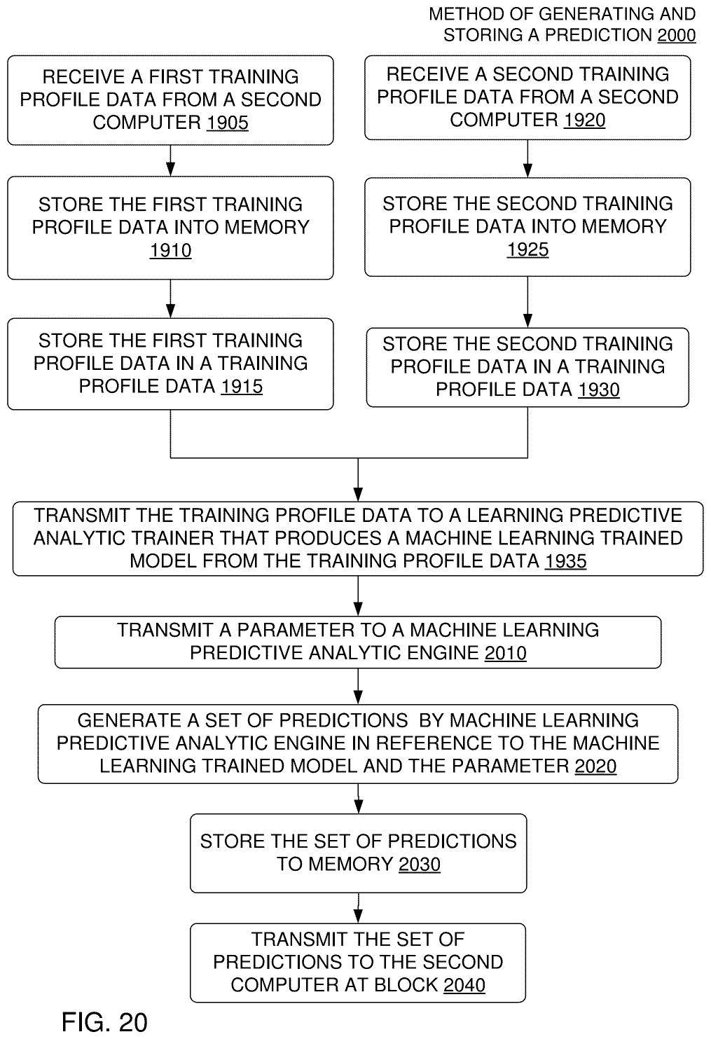

FIG. 4 is a block diagram of an apparatus 400 that is operable to perform machine learning predictive analytics 400 of data that describes features and representations of issues of interest of the entities 410, at least some of which are in common with other training profile data, by a machine learning predictive analytic engine on a predictive analytic control computer, according to an implementation. In some implementations, apparatus 400 performs method 2000 in FIG. 20. The predictive analytic control computer is a first computer in apparatus 400.

Apparatus 400 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 400 includes a third computer 330 that transmits to the memory 210 training profile data 340. The training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes features and representations of issues of interest of the entities 410, at least some of which are in common with other training profile data 320, is transmitted to the machine learning predictive analytic engine 150, and the machine learning predictive analytic engine 150 generates the predictions 160 in reference to the machine learning trained model 130 and the data that describes features and representations of issues of interest of the entities 410, at least some of which are in common with other training profile data 320, and stored to a memory 220. In some implementations, the predictions 160 are transmitted to the second computer 310.

In the implementations of the apparatus 400 in FIG. 4 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of features and representations of issues of interest. The machine learning predictive analytic apparatus 400 of FIG. 4 is highly accurate at generating predictive analytics of future contributions of resources of the particular entities.

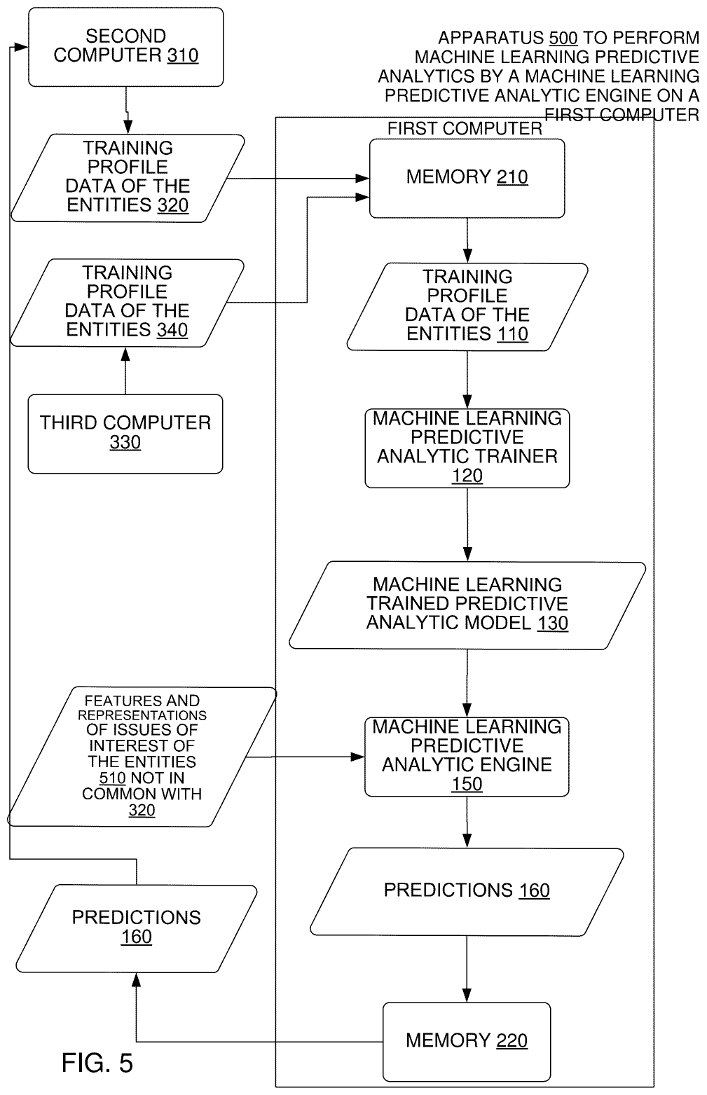

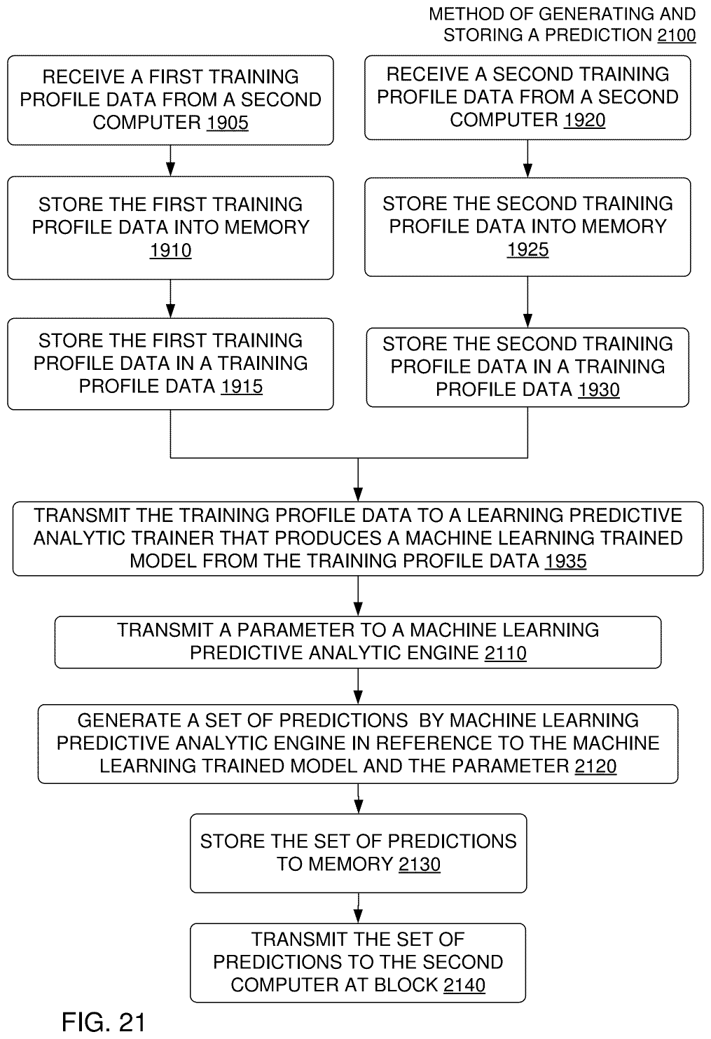

FIG. 5 is a block diagram of an apparatus 500 that is operable to perform machine learning predictive analytics 500 of data that describes features and representations of issues of interest of the entities 510, none of which are in common with other training profile data, by a machine learning predictive analytic engine on a predictive analytic control computer, according to an implementation. In some implementations, apparatus 500 performs method 2100 in FIG. 21. The predictive analytic control computer is a first computer in apparatus 500.

Apparatus 500 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 500 includes a third computer 330 that transmits to the memory 210 training profile data 340. The training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes features and representations of issues of interest of the entities 510, none of which are in common with other training profile data 320, is transmitted to the machine learning predictive analytic engine 150, and the machine learning predictive analytic engine 150 generates the predictions 160 in reference to the machine learning trained model 130 and the data that describes features and representations of issues of interest of the entities 510, none of which are in common with other training profile data 320, and stored to a memory 220. In some implementations, the predictions 160 are transmitted to the second computer 310.

In the implementations of the apparatus 500 in FIG. 5 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of features and representations of issues of interest. The machine learning predictive analytic apparatus 500 of FIG. 5 is highly accurate at generating predictive analytics of future contributions of resources of the particular entities.

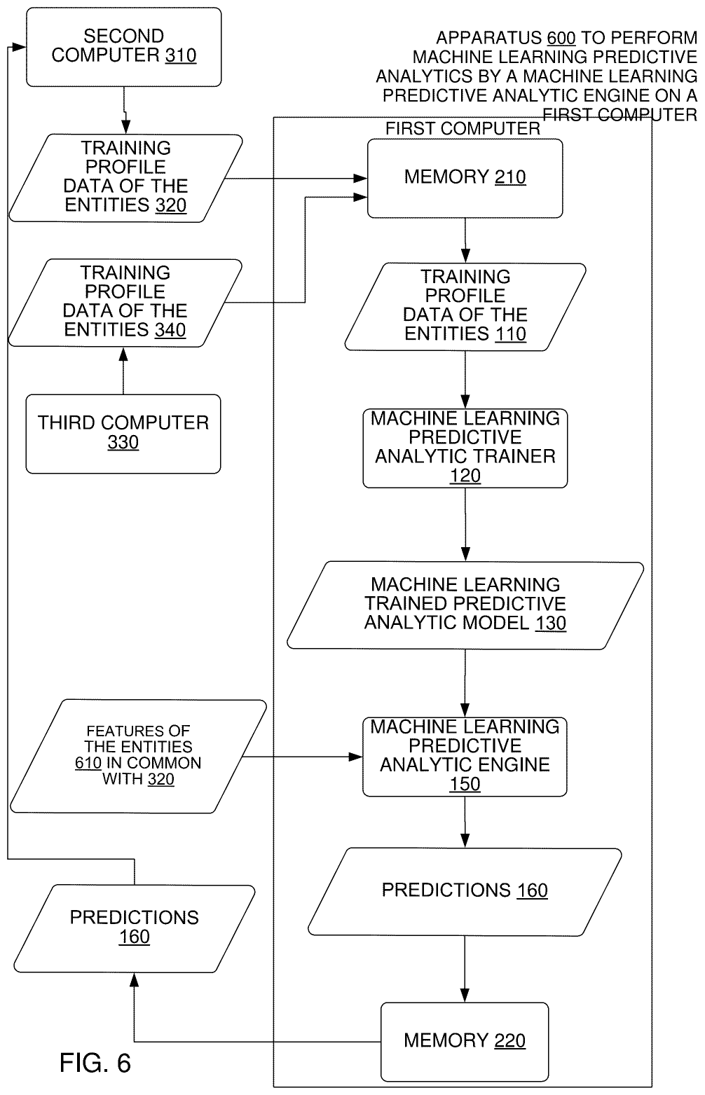

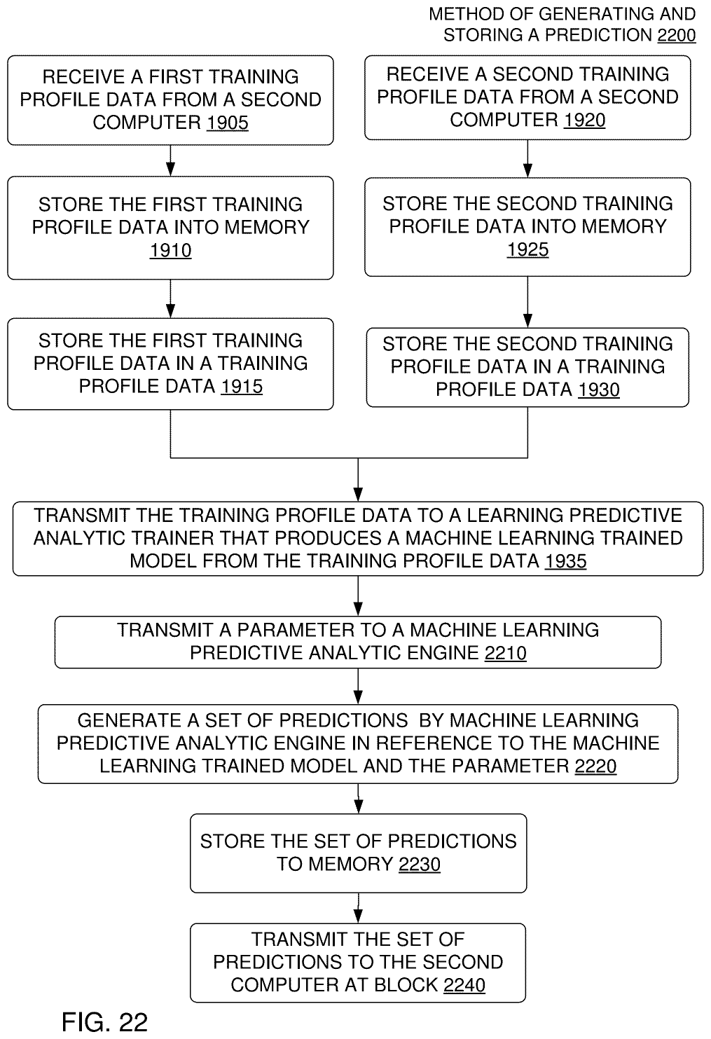

FIG. 6 is a block diagram of an apparatus 600 that is operable to perform machine learning predictive analytics 600 of data that describes features but not representations of issues of interest of the entities 610, at least some of which are in common with other training profile data, by a machine learning predictive analytic engine on a predictive analytic control computer, according to an implementation. In some implementations, apparatus 600 performs method 2200 in FIG. 22. The predictive analytic control computer is a first computer in apparatus 600.

Apparatus 600 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 600 includes a third computer 330 that transmits to the memory 210 training profile data 340. The training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes features but not representations of issues of interest of the entities 610, at least some of which are in common with other training profile data 320, is transmitted to the machine learning predictive analytic engine 150, and the machine learning predictive analytic engine 150 generates the predictions 160 in reference to the machine learning trained model 130 and the data that describes features but not representations of issues of interest of the entities 610, at least some of which are in common with other training profile data 320, and stored to a memory 220. In some implementations, the predictions 160 are transmitted to the second computer 310.

In the implementations of the apparatus 600 in FIG. 6 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of features but not representations of issues of interest. The machine learning predictive analytic apparatus 600 of FIG. 6 is highly accurate at generating predictive analytics of future contributions of resources of the particular entities.

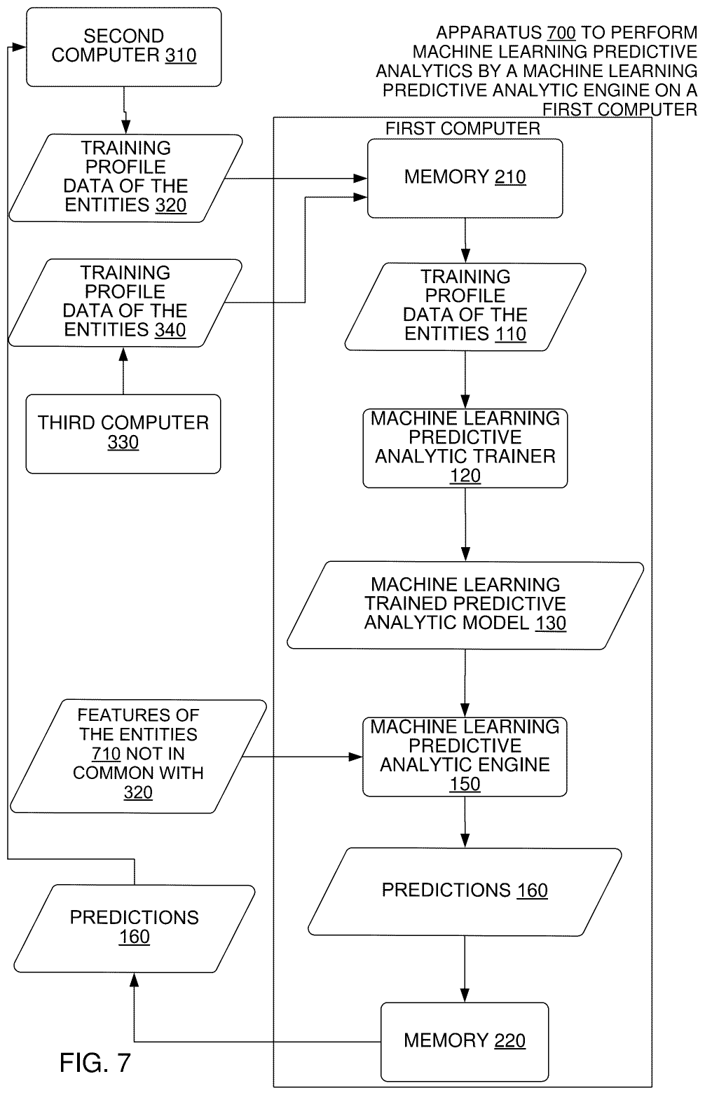

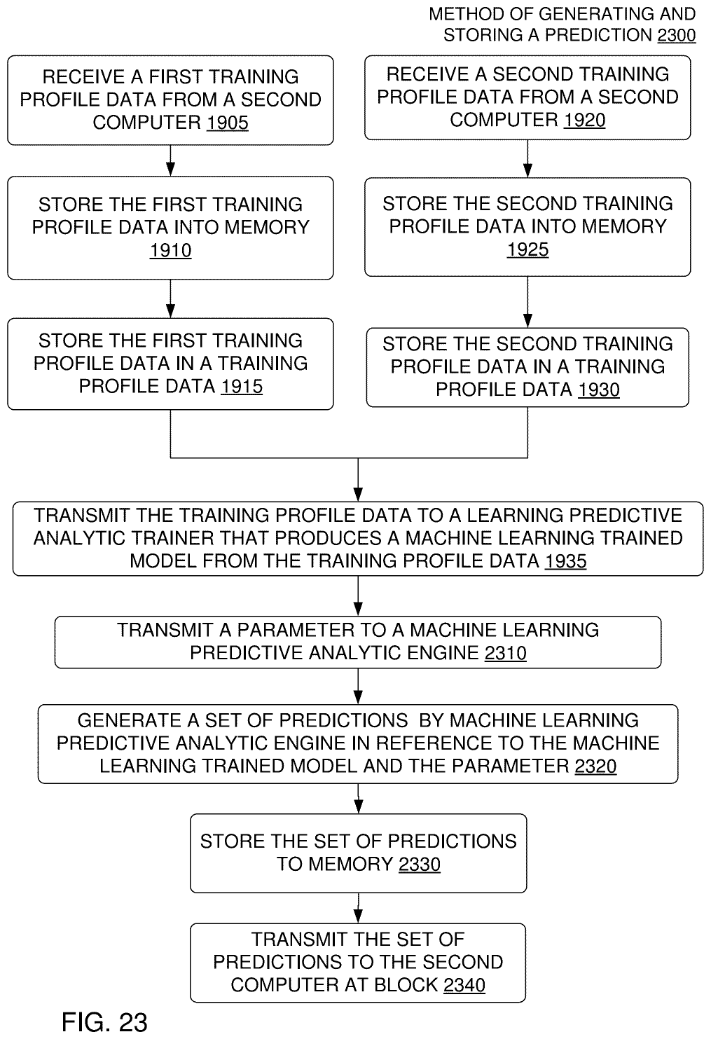

FIG. 7 is a block diagram of an apparatus 700 that is operable to perform machine learning predictive analytics 700 of data that describes features but not representations of issues of interest of the entities 710, none of which are in common with other training profile data, by a machine learning predictive analytic engine on a predictive analytic control computer, according to an implementation. In some implementations, apparatus 700 performs method 1600 in FIG. 23. The predictive analytic control computer is a first computer in apparatus 700.

Apparatus 700 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 700 includes a third computer 330 that transmits to the memory 210 training profile data 340. The training profile data 340 describes one or more contributions of resources that is/are associated and identified with particular entities In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes features but not representations of issues of interest of the entities 710, none of which are in common with other training profile data 320, is transmitted to the machine learning predictive analytic engine 150, and the machine learning predictive analytic engine 150 generates the predictions 160 in reference to the machine learning trained model 130 and the data that describes features but not representations of issues of interest of the entities 710, none of which are in common with other training profile data 320, and stored to a memory 220. In some implementations, the predictions 160 are transmitted to the second computer 310.

In the implementations of the apparatus 700 in FIG. 7 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of features but not representations of issues of interest. The machine learning predictive analytic apparatus 700 of FIG. 7 is highly accurate at generating predictive analytics of future contributions of resources of the particular entities.

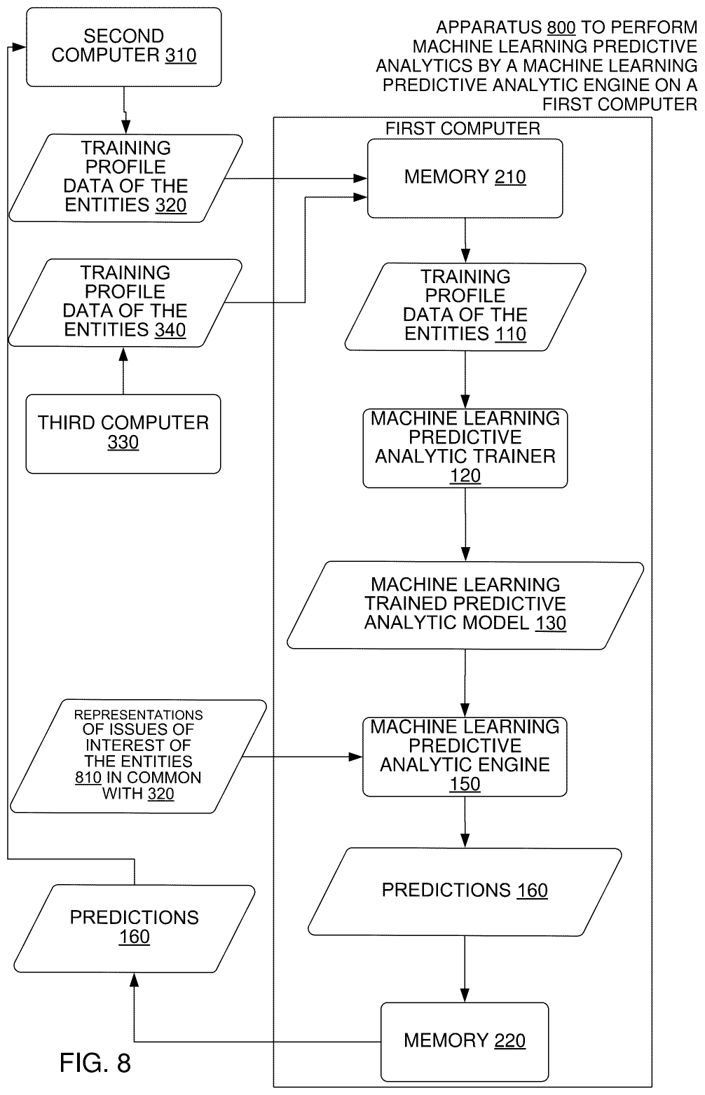

FIG. 8 is a block diagram of an apparatus 800 that is operable to perform machine learning predictive analytics 800 of data that describes representations of issues of interest but not features of the entities 810, at least some of which are in common with other training profile data, by a machine learning predictive analytic engine on a predictive analytic control computer, according to an implementation. In some implementations, apparatus 800 performs method 2400 in FIG. 24. The predictive analytic control computer is a first computer in apparatus 800.

Apparatus 800 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 800 includes a third computer 330 that transmits to the memory 210 training profile data 340. The training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes representations of issues of interest but not features of the entities 810, at least some of which are in common with other training profile data 320, is transmitted to the machine learning predictive analytic engine 150, and the machine learning predictive analytic engine 150 generates the predictions 160 in reference to the machine learning trained model 130 and the data that describes representations of issues of interest but not features of the entities 810, at least some of which are in common with other training profile data 320, and stored to a memory 220. In some implementations, the predictions 160 are transmitted to the second computer 310.

In the implementations of the apparatus 800 in FIG. 8 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of representations of issues of interest features. The machine learning predictive analytic apparatus 800 of FIG. 8 is highly accurate at generating predictive analytics of future contributions of resources of the particular entities.

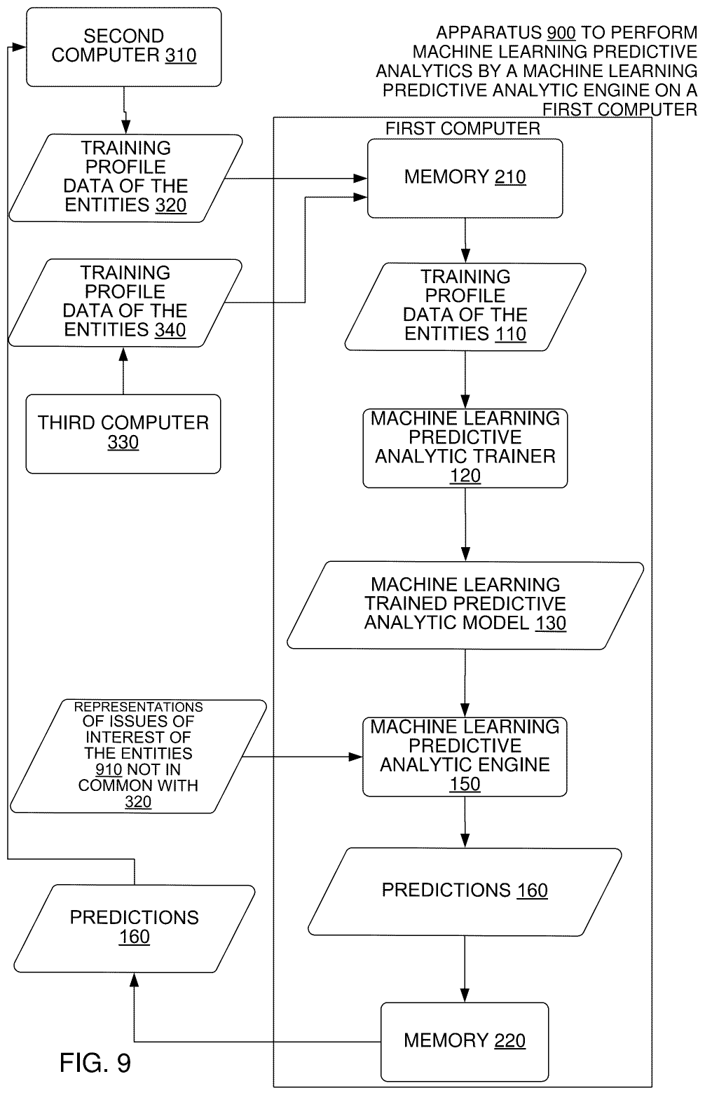

FIG. 9 is a block diagram of an apparatus 900 that is operable to perform machine learning predictive analytics 900 of data that describes representations of issues of interest but not features of the entities 910, none of which are in common with other training profile data, by a machine learning predictive analytic engine on a predictive analytic control computer, according to an implementation. In some implementations, apparatus 900 performs method 2600 in FIG. 26. The predictive analytic control computer is a first computer in apparatus 900.

Apparatus 900 includes a second computer 310 that transmits to the memory 210 training profile data 320. The training profile data 320 is associated and identified with the same particular entities from websites and applications that focus on communication, community-based input, interaction, content-sharing and collaboration that describe the features and representations of issues of interest of the entities. The training profile data 320 is transmitted to the memory 210.

Apparatus 900 includes a third computer 330 that transmits to the memory 210 training profile data 340. The training profile data 340 describes one or more contributions of resources that is/are associated and identified with particular entities. In some implementations, the second computer 310 and the third computer 330 are controlled by different legal entities.

The training profile data 320 and the training profile data 340 is stored in profile data 110 and the profile data 110 is transmitted to the learning predictive analytic trainer 120 that produces a machine learning trained model 130 from the training profile data 110.

The data that describes representations of issues of interest but not features of the entities 910, none of which are in common with other training profile data 320, is transmitted to the machine learning predictive analytic engine 150, and the machine learning predictive analytic engine 150 generates the predictions 160 in reference to the machine learning trained model 130 and the data that describes representations of issues of interest but not features of the entities 910, none of which are in common with other training profile data 320, and stored to a memory 220. In some implementations, the predictions 160 are transmitted to the second computer 310.

In the implementations of the apparatus 900 in FIG. 9 wherein a machine learning trained model is produced from training profile data that describes one or more contributions of resources that is/are associated and identified with particular entities and the training profile data also includes data from websites and applications that focus on communication, community-based input, interaction, content-sharing and collaboration that describe a first set of features and representations of issues of interest of the entities, and then a machine learning predictive analytic engine produces predictive analytics of future contributions of resources of the particular entities from the machine learning trained model in reference to a second set of representations of issues of interest features. The machine learning predictive analytic apparatus 900 of FIG. 9 is highly accurate at generating predictive analytics of future contributions of resources of the particular entities.

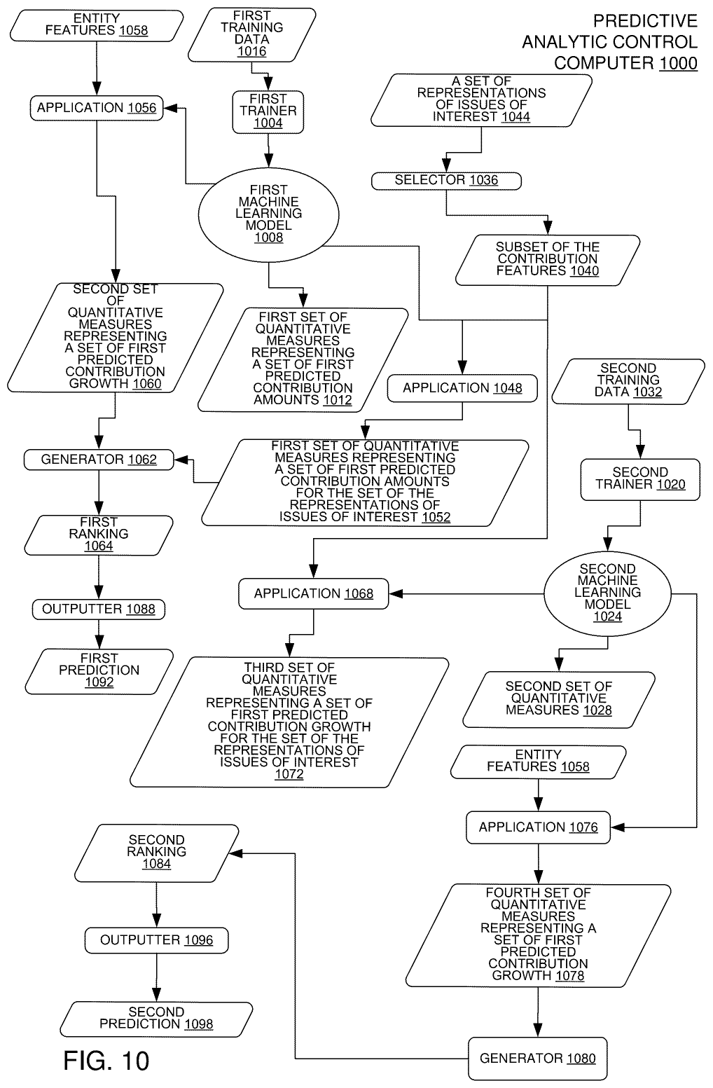

FIG. 10 is a block diagram of a predictive analytic control computer 1000 that is operable to perform machine learning predictive analytics to determine a magnitude of a contribution of resources by an entity in reference to a keyword, according to an implementation. In some implementations, apparatus 1000 performs method 2700 in FIG. 27.

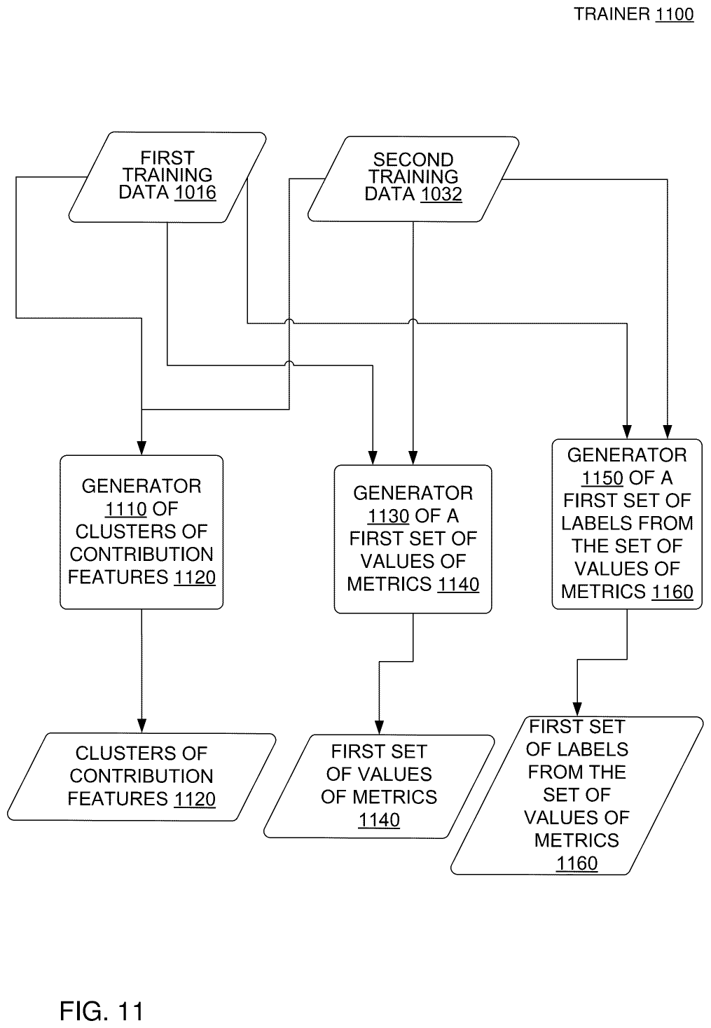

In some implementations, the predictive analytic control computer 1000 includes a first trainer 1004 of a first machine learning model 1008 that is operable to produce a first set of quantitative measures 1012 representing a set of first predicted contribution amounts. The first trainer 1004 receives first training data 1016, such as first training profile data 340 in FIG. 3-9, relating to previous activity of the contribution of the resources of a plurality of entities, from which the first trainer 1004 trains the first machine learning model 1008. Trainer 1100 in FIG. 11 is one example of the first trainer 1004.

In some implementations, the predictive analytic control computer 1000 includes a second trainer 1020 of a second machine learning model 1024 that is operable to produce a second set of quantitative measures 1028 representing a set of second predicted contribution amounts. The second trainer 1020 receives second training data 1032, such as second training profile data 320 in FIG. 3-9, that describe the features and representations of issues of interest of the entities of a plurality of entities, from which the second trainer 1020 trains the second machine learning model 1024. Trainer 1100 in FIG. 11 is one example of the second trainer 1020.

In some implementations, the predictive analytic control computer 1000 includes a selector 1036 of a subset of the contribution features 1040 characterizing the contribution activity by the entity, for a selected subset of a set of representations of issues of interest 1044. The selector 1036 is operable in reference to a normalized ranking of the subset of the contribution features, yielding the selected subset of contribution features 1040.

In some implementations, the predictive analytic control computer 1000 also includes an application 1048 of the first machine learning model 1008 to the selected contribution features 1040 to produce a first set of quantitative measures 1052 representing the predicted contribution amounts by the entity for the set of the representations of issues of interest.

In some implementations, the predictive analytic control computer 1000 also includes an application 1056 of the first machine learning model 1008 to a set of entity features 1058 to produce a second set 1060 of quantitative measures representing the predicted contribution growth.

In some implementations, the predictive analytic control computer 1000 also includes a generator 1062 of a first ranking 1064 of the set of the representations of issues of interest by the first set of quantitative measures 1052 and the second set of quantitative measures 1060.

In some implementations, the predictive analytic control computer 1000 also includes an application 1068 of the second machine learning model 1024 to the selected contribution features 1040 to produce a third set 1072 of quantitative measures representing the predicted contribution growth by the entity for the set of the representations of issues of interest.

In some implementations, the predictive analytic control computer 1000 also includes an application 1076 of the second machine learning model 1024 to the set of entity features 1058 to produce a fourth set 1078 of quantitative measures.

In some implementations, the predictive analytic control computer 1000 also includes a generator 1080 of a second ranking 1084 of the set of the representations of issues of interest by the third set of quantitative measures and the fourth set 1076 of quantitative measures.

In some implementations, the predictive analytic control computer 1000 also includes an outputter 1088 of at least a portion of the first ranking as a first prediction 1092 of the predicted contribution amounts by the entity for the set of the representations of issues of interest.

In some implementations, the predictive analytic control computer 1000 also includes an outputter 1096 of at least a portion of the second ranking as a second prediction 1098 of the predicted contribution growth by the entity for the set of the representations of issues of interest.

FIG. 11 is a block diagram of a trainer 1100 in a predictive analytic control computer that is operable to train a machine learning model to produce a first set of quantitative measures representing a set of quantitative measures representing previous activity of the contribution of the resources of the plurality of entities or train a machine learning model to produce a second set of quantitative measures representing a set of second predicted contribution growth, according to an implementation. In some implementation trainer 1100 performs block 2710 in FIG. 27. In some implementation trainer 1100 performs block Method 2800 in FIG. 28. Trainer 1100 in FIG. 11 is one example of the first trainer 1020 in FIG. 10.

Trainer 1100 includes a generator 1110 of clusters of contribution features 1120 that are associated with identified patterns of contribution activity, using k-means clustering, from the first training data 1016 or the second training data 1032.

In some implementations, trainer 1100 also includes a generator 1130 of a first set of values of metrics 1140 related to the contribution activity over a first time period, from the first training data 1016 or the second training data 1032.

In some implementations, trainer 1100 also includes a generator 1150 of a first set of labels from the set of values of metrics 1160 related to the contribution activity over a second time period, from the first training data 1016 or the second training data 1032.

In some implementations, the trainer 1100 also includes a generator 1170 of a normalized ranking of the contribution features 1180 based on the first set of labels and the second set of labels.

An example of the first training data 1016 is the first training profile data 340 in FIG. 3-9, which relates to previous activity of the contribution of the resources of a plurality of entities, from which the first trainer 1004 trains the first machine learning model 1008.

An example of the second training data 1032 is the second training profile data 320 in FIG. 3-9, that describes the features and representations of issues of interest of the entities of a plurality of entities, from which the first trainer 1004 trains the first machine learning model 1008.

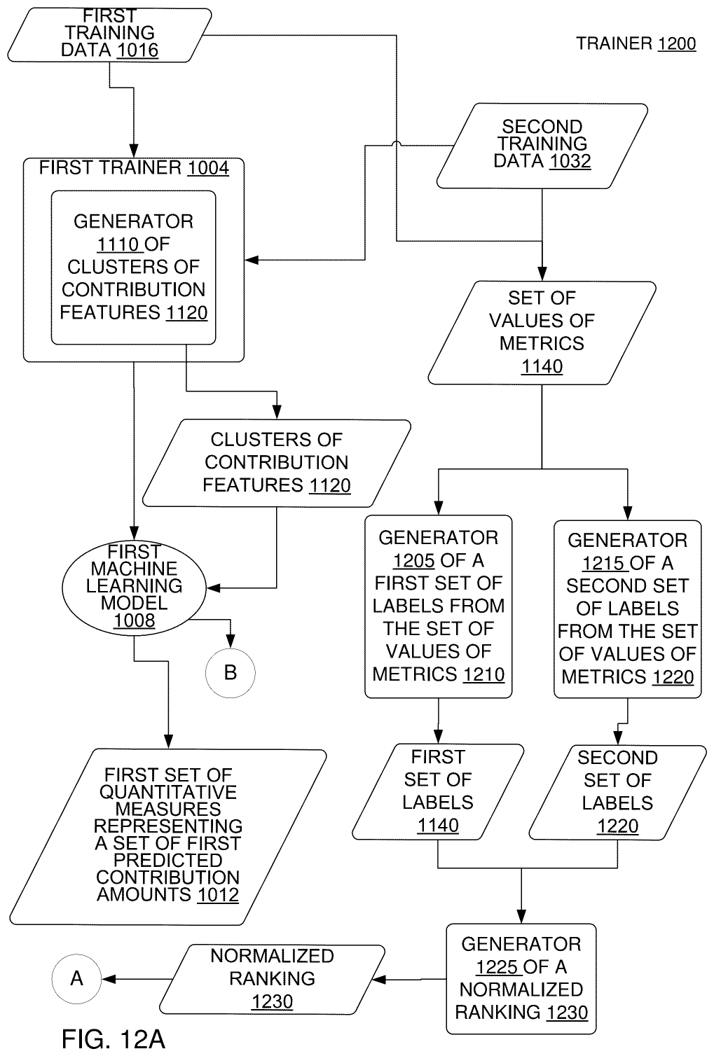

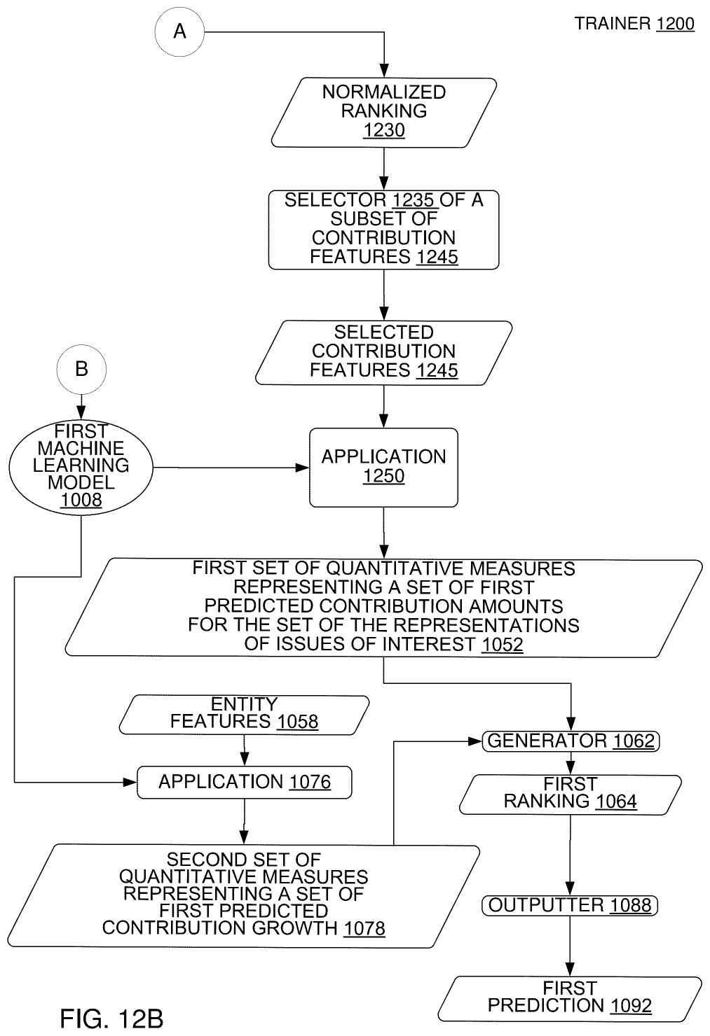

FIG. 12A and FIG. 12B are a block diagram of a trainer 1200 in a predictive analytic control computer, according to an implementation. Trainer 1200 performs machine learning predictive analytics to determine a magnitude of a contribution of resources by an entity in reference to a keyword, the trainer 1200 being in a microprocessor in a predictive analytic control computer, according to an implementation. In some implementations, trainer 1200 performs method 2900 in FIG. 29. Apparatus 1200 in FIG. 12 is one example of the first trainer 1020 in FIG. 10.

In some implementations, the apparatus 1200 includes with first training data 1016 relating to previous activity of contribution of the resources of a plurality of entities, a trainer 1004 of a first machine learning model 1008 to produce a first set of quantitative measures 1012 representing predicted contribution amounts. In some implementations, the trainer 1004 also includes a generator 1110 of clusters of contribution features 1120 that are associated with identified patterns of contribution activity, using k-means clustering, from the first training data 1016 or the second training data 1032.

In some implementations, the apparatus 1200 also includes a generator 1205 of a first set of labels 1210 from the set of metrics related to the contribution activity over a first time period.

In some implementations, the apparatus 1200 also includes a generator 1150 of a second set of labels 1215 from the set of values of metrics 1220 related to the contribution activity over a second time period.

In some implementations, the apparatus 1200 also includes a generator 1225 of a normalized ranking 1230 of the contribution features based on the first set of labels 1140 and the second set of labels 1220.

In some implementations, the apparatus 1200 also includes a selector 1235 of a subset of contribution features 1240 characterizing the contribution activity by the entity for a set of representations of issues of interest. In some implementations, the selector performs the normalized ranking of the subset of contribution features, yielding selected contribution features 1245.

In some implementations, the apparatus 1200 also includes an application 1250 of the first machine learning model 1008 to the selected contribution features 1245 to produce a first set of quantitative measures 1052 representing the predicted contribution amounts by the entity for the set of the representations of issues of interest.

In some implementations, the apparatus 1200 also includes an application 1255 of the first machine learning model 1008 to a set of entity features 1058 to produce a second set 1060 of quantitative measures representing the predicted contribution growth.

In some implementations, the apparatus 1200 also includes the generator 1062 of the first ranking 1064 of the set of the representations of issues of interest by the first set of quantitative measures and the second set of quantitative measures.

In some implementations, the apparatus 1200 also includes an outputter 1088 of at least a portion of the first ranking 1064 as a first prediction 1092 of the set of the predicted contribution amounts by the entity for the set of the representations of issues of interest.

In some implementations of the apparatus in FIG. 10-12, the set of the entity features include at least one of an identifier (SSN) of the entity, a name of the entity, a net worth of the entity, an age of the entity, a gender of the entity, a work title of the entity, an industry of the entity, a location zip code. In some implementations of the apparatus in FIG. 10-12, the contribution features include at least one of a contribution date, a contribution amount, a donee name.

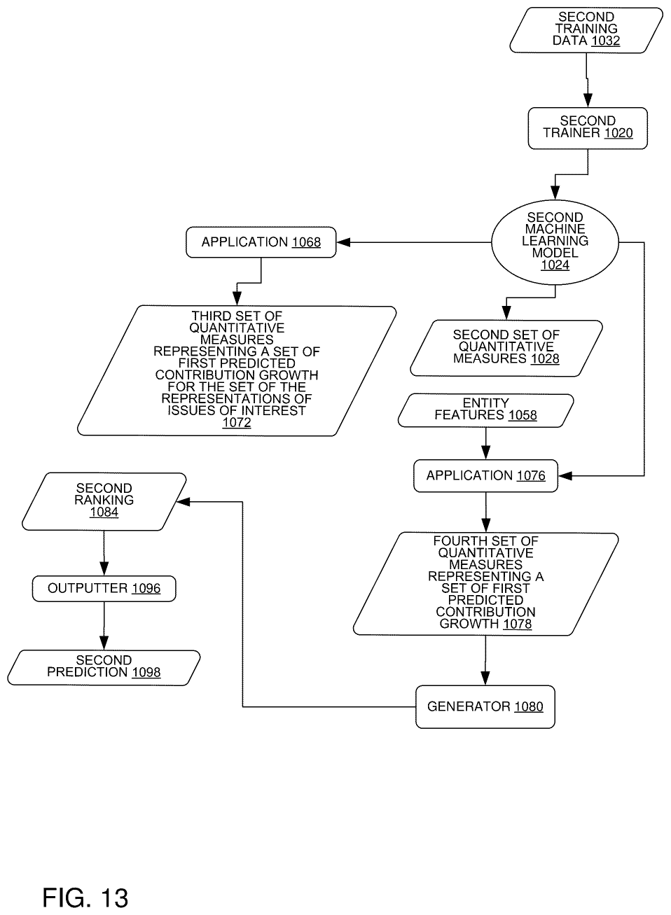

FIG. 13 is a block diagram of an apparatus 1300 that is operable to perform machine learning predictive analytics to determine a magnitude of a contribution of resources by an entity in reference to a keyword, the apparatus is implemented in a microprocessor in a predictive analytic control computer, according to an implementation. Apparatus 1300 performs method 3000 in FIG. 30.

In some implementations, the apparatus 1300 includes a trainer 1020 of a second machine learning model 1024 to produce a second set of quantitative measures representing predicted contribution growth amounts 1028.

In some implementations, the apparatus 1300 also includes an application 1068 of the second machine learning model 1024 to the selected contribution features to produce a third set of quantitative measures representing predicted contribution growth by the entity for the set of the representations of issues of interest 1072.

In some implementations, the apparatus 1300 also includes an application 1068 of the second machine learning model 1024 to a set of the entity features to produce a fourth set of quantitative measures 1078.

In some implementations, the apparatus 1300 also includes a generator 1080 of a second ranking 1084 of the set of the representations of issues of interest by the third set of quantitative measures 1072 and the fourth set of quantitative measures 1078.

In some implementations, the apparatus 1300 also includes an outputter 1096 at least a portion of the second ranking 1084 as a second prediction 1098 of the predicted contribution growth by the entity for the set of the representations of issues of interest.

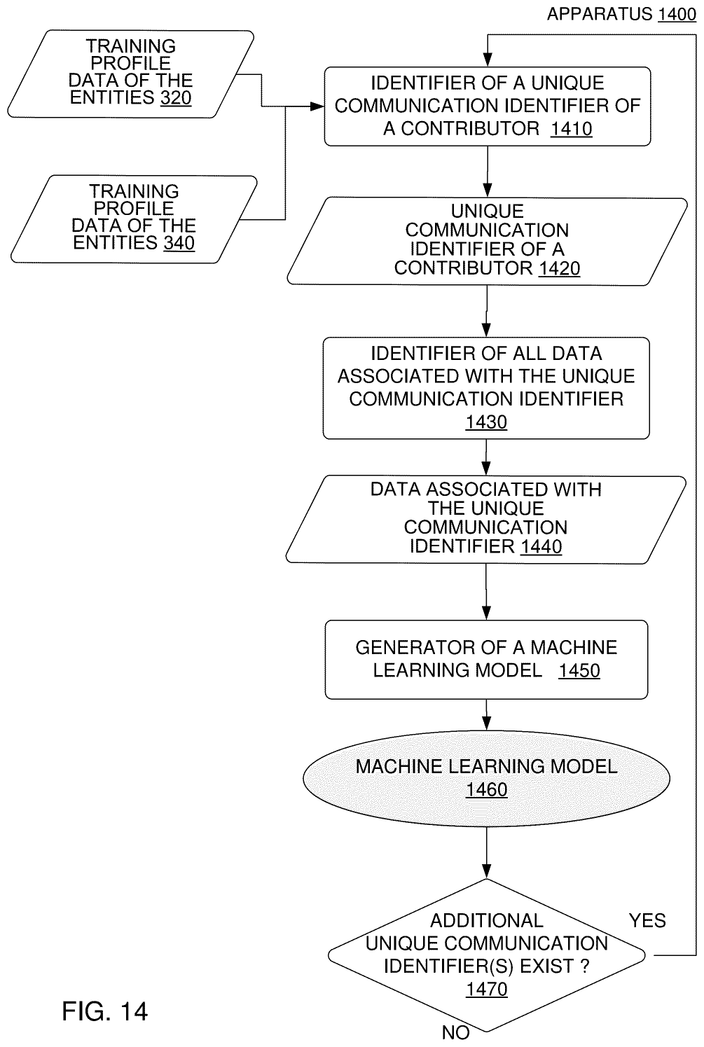

FIG. 14 is a block diagram of an apparatus 1400 that is operable to perform machine learning predictive analytics to generate communications to contributors, according to an implementation.

FIG. 14 includes an identifier 1410 of a unique communication identifier of a contributor 1420 from a trainer of profile data of the entities. Examples of the trainer include 120 in FIGS. 1-9 and 1004 and 1020 in FIG. 10. Examples of the communication identifier is an email address, a facebook ID and an “X” ID.

Apparatus 1400 also includes an identifier 1430 of all data associated with the unique communication identifier of the contributor 1440.

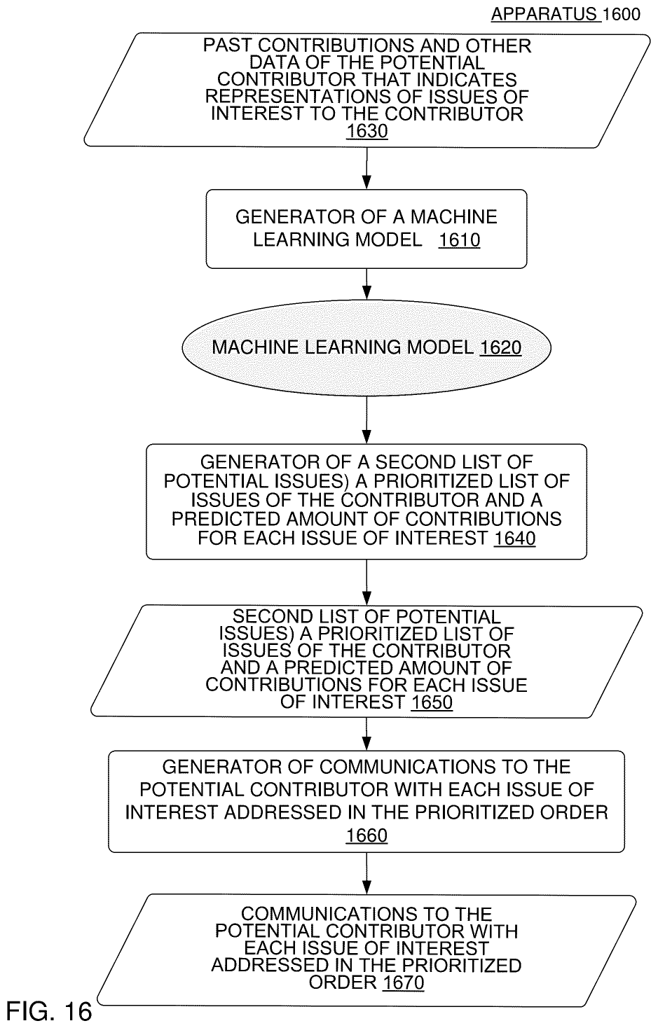

Apparatus 1400 also includes a generator 1450 of a machine learning model 1460 from the associated data and generating communications to the contributor from the machine learning model. One implementation of block 3130 is apparatus 1600 in FIG. 16.

Apparatus 1400 also includes a determiner 1470 of whether or not additional unique communication identifier(s) exist in the trainer of profile data of the entities 320 and 340. If additional unique communication identifier(s) exist in the trainer of profile data of the entities 320 and 340, then the apparatus continues at block 1410. If no additional unique communication identifier(s) exist in the trainer of profile data of the entities 320 and 340, then the apparatus 1400 stops operating.

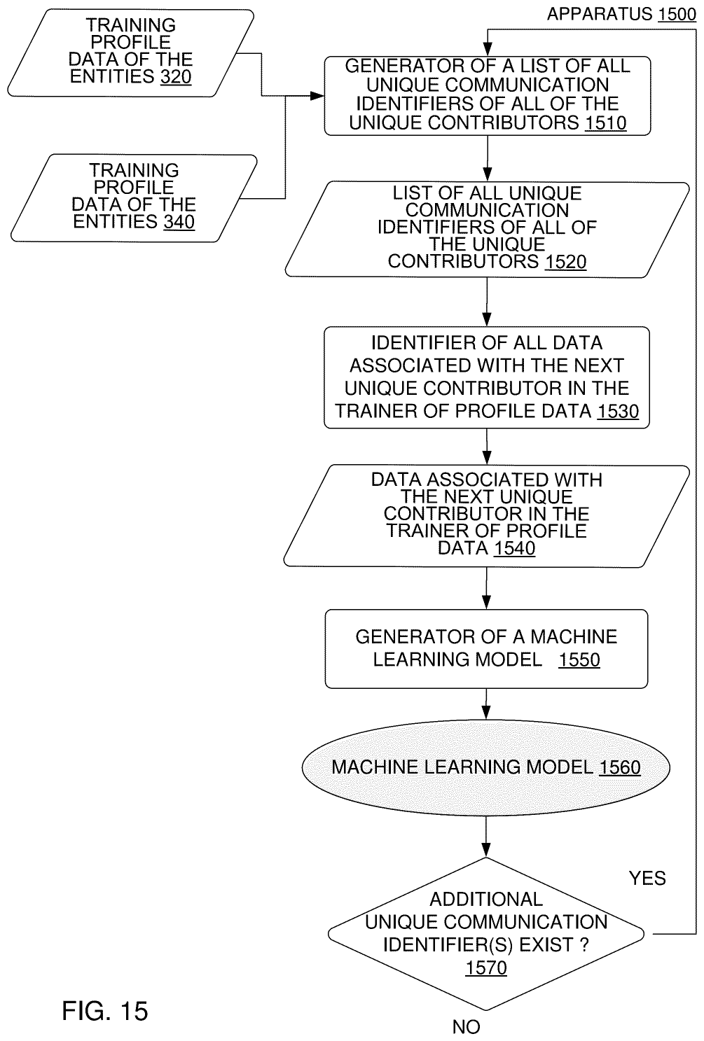

FIG. 15 is a block diagram of an apparatus 1500 that is operable to perform machine learning predictive analytics to generate communications to contributors, according to an implementation.

FIG. 15 includes a generator 1510 of a list 1520 of all unique communication identifiers of all of the unique contributors in the profile data of the entities 320 and 340. Examples of a trainer of profile data is the trainer of profile data 320 and the trainer of profile data 340 in FIG. 3-9. Examples of a communication identifier is an email address, a facebook ID and an “X” ID.

Apparatus 1500 also includes an identifier 1530 of all data 1540 associated with the next unique contributor in the trainer of profile data of the entities 320 and 340.

Apparatus 1500 also includes a generator 1550 of a machine learning model 1560 from the associated data 1540.

Apparatus 1500 also includes a determiner 1570 of whether or not more unique contributors exist in the list. If more unique contributors exist in the list, then the apparatus continues at block 1510. If no more unique contributors exist in the list, then the apparatus 1500 stops operating.

FIG. 16 is a block diagram of an apparatus 1600 of generating a machine learning model from the associated data and generating communications to the contributor from the machine learning model, according to an implementation. In some implementations, apparatus 1600 performs method 3300 in FIG. 33. Apparatus 1600 executes for each potential contributor entity.

In some implementations, apparatus 1600 includes a generator 1610 of a machine learning model 1620 based on past contributions and other data of the potential contributor that indicates representations of issues of interest to the contributor 1630.

In some implementations, apparatus 1600 includes a generator 1640 (from the model 1620 and a second list of potential issues) a prioritized list of issues of the contributor and a predicted amount of contributions for each issue of interest 1650.

In some implementations, apparatus 1600 includes a generator 1660 (from the prioritized list of issues 1650) communications to the potential contributor with each issue of interest addressed in the prioritized order 1670.

### Method Implementations

In the previous section, apparatus of the operation of implementations are described. In this section, the particular methods performed by a processor, such as processor 3402 in FIG. 34, processing unit 3604 in FIG. 36 and main processor 3702 in FIG. 37 of such an implementation are described by reference to a series of flowcharts.

FIG. 17 is a flowchart of a method 1700 of generating and storing a prediction according to an implementation. Method 1700 is performed by a machine learning predictive analytic engine, such as machine learning predictive analytic engine 150, according to an implementation. Method 1700 provides predictive analytics on training profile data, by a machine learning predictive analytic engine, and generates predictions accordingly.

Method 1700 includes a receiving from a memory plurality of new data, at block 1710. In some implementations, the new data is data that describes at least one feature of particular entities. In some implementations, the new data is sourced from one or more entities that are not the particular entities.

Method 1700 also includes generating the prediction by a machine learning predictive analytic engine in reference to the new data, at block 1720. The machine learning predictive analytic engine generates a plurality of predictions. In some implementations, the machine learning predictive analytic engine is inside (or behind) a data perimeter and no other machine learning predictive analytic engines have access to the confidential data inside (or behind) the data perimeter. In some implementations, the machine learning predictive analytic engine is inside (or behind) the data perimeter and no other machine learning predictive analytic engines have access to the confidential data inside (or behind) the data perimeter. In some implementations, the machine learning predictive analytic engine references only data (including the parameter 140) inside (or behind) the data perimeter. In some implementations, the confidential data is only stored inside the data perimeter. In some implementations, the data further includes data outside of the data perimeter, such as the data archive of Common Crawl or San Francisco and WebText2 by Eleuther AI and wikilpedia.com. In some implementations, the machine learning predictive analytic engine includes computer instructions that when executed perform a machine learning linear regression process, a machine learning logistic regression process, a machine learning decision tree process, a machine learning SVM process, a machine learning Naive Bayes process, a machine learning KNN process, a machine learning linear K-means process, a machine learning random forest process, a machine learning dimensionality reduction process, a machine learning gradient boosting process or a machine learning ADA boosting process.

Method 1700 also includes storing the plurality of predictions to a memory, at block 1730.

FIG. 18 is a flowchart of a method 1800 of generating and storing a prediction, according to an implementation of FIG. 1 and FIG. 2. Method 1800 is performed by a machine learning predictive analytic engine, according to an implementation. Method 1800 provides predictive analytics on training profile data by a machine learning predictive analytic engine and generates predictions accordingly.

Method 1800 includes training a machine learning predictive analytic engine in reference to new data, at block 1810. In some implementations, the new data is data that describe at least one feature of the particular entities. In some implementations, the new data is sourced from one or more entities that are not the particular entities.

Method 1800 includes receiving from a memory a plurality of training profile data, at block 1710. Method 1800 also includes generating the predictions by a machine learning predictive analytic engine in reference to new data, at block 1720. The machine learning predictive analytic engine generates a plurality of predictions.

Method 1800 also includes storing the plurality of predictions to a memory, at block 1730.

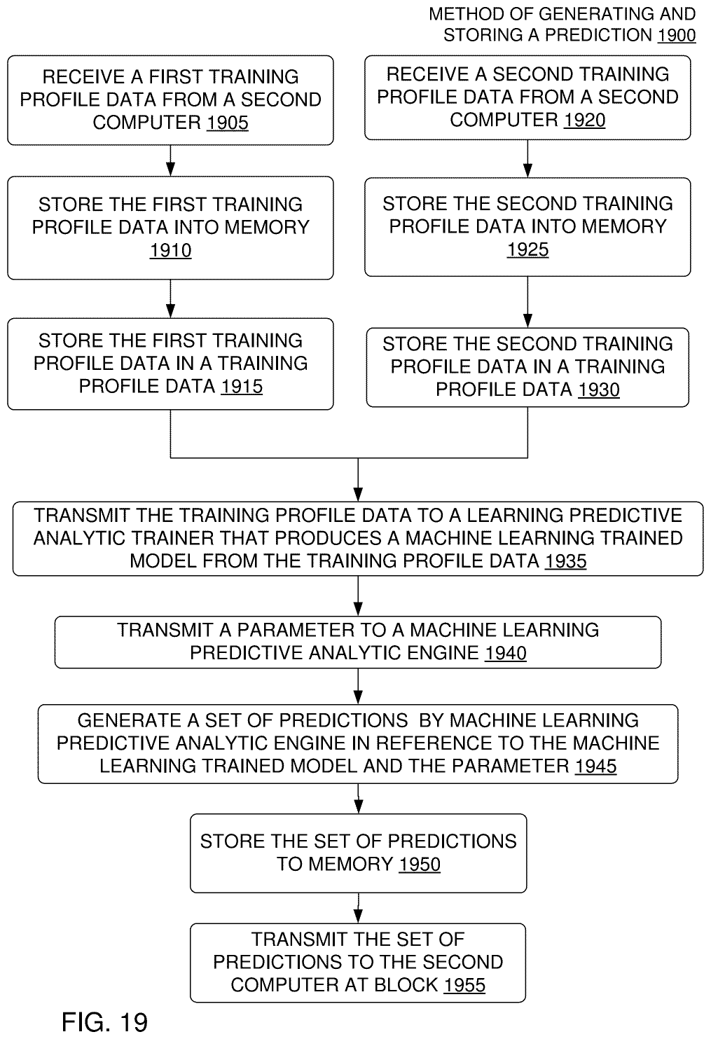

FIG. 19 is a flowchart of a method 1900 of generating and storing a prediction according to an implementation of FIG. 3 in reference to new data and from training data that describes one or more contributions of resources and from training data that describes features and representations of issues of interest of the entities. Method 1900 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 1900 provides predictive analytics on the training data, by a machine learning predictive analytic engine, and generates predictions accordingly. The predictive analytic control computer is a first computer in apparatus 300.

Some implementations of the method 1900 include receiving a first training profile data (such as training profile data 320 in FIG. 3) from a second computer (such as second computer 310 in FIG. 3), at block 1905.

Some implementations of the method 1900 include storing the first training profile data into a memory (such as memory 210), at block 1910.

Some implementations of the method 1900 include storing the first training profile data in a training profile data (such as the training profile data 110 in FIG. 3), at block 1915.

Some implementations of the method 1900 include receiving a second training profile data (such as training profile data 320 in FIG. 3) from a second computer (such as second computer 340 in FIG. 3), at block 1920.

Some implementations of the method 1900 include storing the second training profile data into a memory (such as memory 210), at block 1925.

Some implementations of the method 1900 include storing the second training profile data in a training profile data (such as the training profile data 110 in FIG. 3), at block 1930.

Some implementations of the method 1900 include transmitting the training profile data to a learning predictive analytic trainer (such as the learning predictive analytic trainer 120 in FIG. 3) that produces a machine learning trained model (such as the machine learning trained model 130 in FIG. 3) from the training profile data, at block 1935.

Some implementations of the method 1900 include transmitting a parameter (such as parameter 140 in FIG. 3) to a machine learning predictive analytic engine (such as the machine learning predictive analytic engine 150 in FIG. 3), at block 1940.

Some implementations of the method 1900 include generating a set of predictions (such as the predictions 160 in FIG. 3) by machine learning predictive analytic engine (such as by machine learning predictive analytic engine 150 in FIG. 3) in reference to the machine learning trained model (such as the machine learning trained model 130 in FIG. 1) and the parameter (such as parameter 140 in FIG. 3), at block 1945.

Some implementations of the method 1900 include storing the set of predictions (such as the predictions 160 in FIG. 3) to a memory (such as memory 220 in FIG. 3), at block 1950.

Some implementations of the method 1900 include transmitting the set of predictions (such as the predictions 160 in FIG. 3) to the second computer (such as second computer 310 in FIG. 3), at block 1955.

FIG. 20 is a flowchart of a method 2000 of generating and storing a prediction according to an implementation of FIG. 4 in reference to new data and from training data that describes features and representations of issues of interest of the entities that are in common with training data that describes one or more contributions of resources. Method 2000 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2000 provides predictive analytics on the training data, by a machine learning predictive analytic engine, and generates predictions accordingly. The predictive analytic control computer is a first computer in apparatus 400.

Some implementations of the method 2000 include receiving a first training profile data (such as training profile data 320 in FIG. 4) from a second computer (such as second computer 310 in FIG. 4), at block 1905.

Some implementations of the method 2000 include storing the first training profile data into a memory (such as memory 210), at block 1910.

Some implementations of the method 2000 include storing the first training profile data in a training profile data (such as the training profile data 110 in FIG. 4), at block 1915.

Some implementations of the method 2000 include receiving a second training profile data (such as training profile data 320 in FIG. 4) from a second computer (such as second computer 340 in FIG. 4), at block 1920.

Some implementations of the method 2000 include storing the second training profile data into a memory (such as memory 210), at block 1925.

Some implementations of the method 2000 include storing the second training profile data in a training profile data (such as the training profile data 110 in FIG. 4), at block 1930.

Some implementations of the method 2000 include transmitting the training profile data to a learning predictive analytic trainer (such as the learning predictive analytic trainer 120 in FIG. 4) that produces a machine learning trained model (such as the machine learning trained model 130 in FIG. 4) from the training profile data, at block 1935.

Some implementations of the method 2000 include transmitting a parameter (such as parameter 410 in FIG. 4) to a machine learning predictive analytic engine (such as the machine learning predictive analytic engine 150 in FIG. 4), at block 2010.

Some implementations of the method 2000 include generating a set of predictions (such as the predictions 160 in FIG. 4) by machine learning predictive analytic engine (such as by machine learning predictive analytic engine 150 in FIG. 4) in reference to the machine learning trained model (such as the machine learning trained model 130 in FIG. 1) and the parameter (such as parameter 410 in FIG. 4), at block 2020.

Some implementations of the method 2000 include storing the set of predictions (such as the predictions 160 in FIG. 4) to a memory (such as memory 220 in FIG. 2), at block 2030.

Some implementations of the method 2000 include transmitting the set of predictions (such as the predictions 160 in FIG. 4) to the second computer (such as second computer 310 in FIG. 4), at block 2040.

FIG. 21 is a flowchart of a method 2100 of generating and storing a prediction according to an implementation of FIG. 5 in reference to new data and from training data that describes features and representations of issues of interest of the entities that are not in common with training data that describes one or more contributions of resources. Method 2100 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2100 provides predictive analytics on the training data, by a machine learning predictive analytic engine, and generates predictions accordingly. The predictive analytic control computer is a first computer in apparatus 500.

Some implementations of the method 2100 include receiving a first training profile data (such as training profile data 320 in FIG. 5) from a second computer (such as second computer 310 in FIG. 5), at block 1905.

Some implementations of the method 2100 include storing the first training profile data into a memory (such as memory 210), at block 1910.

Some implementations of the method 2100 include storing the first training profile data in a training profile data (such as the training profile data 110 in FIG. 5), at block 1915.

Some implementations of the method 2100 include receiving a second training profile data (such as training profile data 320 in FIG. 5) from a second computer (such as second computer 340 in FIG. 5), at block 1920.

Some implementations of the method 2100 include storing the second training profile data into a memory (such as memory 210), at block 1925.

Some implementations of the method 2100 include storing the second training profile data in a training profile data (such as the training profile data 110 in FIG. 5), at block 1930.

Some implementations of the method 2100 include transmitting the training profile data to a learning predictive analytic trainer (such as the learning predictive analytic trainer 120 in FIG. 5) that produces a machine learning trained model (such as the machine learning trained model 130 in FIG. 5) from the training profile data, at block 1935.

Some implementations of the method 2100 include transmitting a parameter (such as parameter 510 in FIG. 5) to a machine learning predictive analytic engine (such as the machine learning predictive analytic engine 150 in FIG. 5), at block 2210.

Some implementations of the method 2100 include generating a set of predictions (such as the predictions 160 in FIG. 5) by machine learning predictive analytic engine (such as by machine learning predictive analytic engine 150 in FIG. 5) in reference to the machine learning trained model (such as the machine learning trained model 130 in FIG. 1) and the parameter (such as parameter 510 in FIG. 5), at block 2120.

Some implementations of the method 2100 include storing the set of predictions (such as the predictions 160 in FIG. 5) to a memory (such as memory 220 in FIG. 5), at block 2130.

Some implementations of the method 2100 include transmitting the set of predictions (such as the predictions 160 in FIG. 5) to the second computer (such as second computer 310 in FIG. 5), at block 2140.

FIG. 22 is a flowchart of a method 2200 of generating and storing a prediction according to an implementation of FIG. 6 in reference to new data and from training data that describes features of the entities that are in common with training data that describes one or more contributions of resources. Method 2200 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2200 provides predictive analytics on the training data, by a machine learning predictive analytic engine, and generates predictions accordingly. The predictive analytic control computer is a first computer in apparatus 600.

Some implementations of the method 2200 include receiving a first training profile data (such as training profile data 320 in FIG. 6) from a second computer (such as second computer 310 in FIG. 6), at block 1905.

Some implementations of the method 2200 include storing the first training profile data into a memory (such as memory 210), at block 1910.

Some implementations of the method 2200 include storing the first training profile data in a training profile data (such as the training profile data 110 in FIG. 6), at block 1915.

Some implementations of the method 2200 include receiving a second training profile data (such as training profile data 320 in FIG. 6) from a second computer (such as second computer 340 in FIG. 6), at block 1920.

Some implementations of the method 2200 include storing the second training profile data into a memory (such as memory 210), at block 1925.

Some implementations of the method 2200 include storing the second training profile data in a training profile data (such as the training profile data 110 in FIG. 6), at block 1930.

Some implementations of the method 2200 include transmitting the training profile data to a learning predictive analytic trainer (such as the learning predictive analytic trainer 120 in FIG. 6) that produces a machine learning trained model (such as the machine learning trained model 130 in FIG. 6) from the training profile data, at block 1935.

Some implementations of the method 2200 include transmitting a parameter (such as parameter 610 in FIG. 6) to a machine learning predictive analytic engine (such as the machine learning predictive analytic engine 150 in FIG. 6), at block 2210.

Some implementations of the method 2200 include generating a set of predictions (such as the predictions 160 in FIG. 6) by machine learning predictive analytic engine (such as by machine learning predictive analytic engine 150 in FIG. 6) in reference to the machine learning trained model (such as the machine learning trained model 130 in FIG. 1) and the parameter (such as parameter 610 in FIG. 6), at block 2220.

Some implementations of the method 2200 include storing the set of predictions (such as the predictions 160 in FIG. 6) to a memory (such as memory 220 in FIG. 6), at block 2230.

Some implementations of the method 2200 include transmitting the set of predictions (such as the predictions 160 in FIG. 6) to the second computer (such as second computer 310 in FIG. 6), at block 2240.

FIG. 23 is a flowchart of a method 2300 of generating and storing a prediction according to an implementation of FIG. 7 in reference to new data and from training data that describes features of the entities that are not in common with training data that describes one or more contributions of resources. Method 2300 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2300 provides predictive analytics on the training data, by a machine learning predictive analytic engine, and generates predictions accordingly. The predictive analytic control computer is a first computer in apparatus 700.

Some implementations of the method 2300 include receiving a first training profile data (such as training profile data 320 in FIG. 7) from a second computer (such as second computer 310 in FIG. 7), at block 1905.

Some implementations of the method 2300 include storing the first training profile data into a memory (such as memory 210), at block 1910.

Some implementations of the method 2300 include storing the first training profile data in a training profile data (such as the training profile data 110 in FIG. 7), at block 1915.

Some implementations of the method 2300 include receiving a second training profile data (such as training profile data 320 in FIG. 7) from a second computer (such as second computer 340 in FIG. 7), at block 1920.

Some implementations of the method 2300 include storing the second training profile data into a memory (such as memory 210), at block 1925.

Some implementations of the method 2300 include storing the second training profile data in a training profile data (such as the training profile data 110 in FIG. 7), at block 1930.

Some implementations of the method 2300 include transmitting the training profile data to a learning predictive analytic trainer (such as the learning predictive analytic trainer 120 in FIG. 7) that produces a machine learning trained model (such as the machine learning trained model 130 in FIG. 7) from the training profile data, at block 1935.

Some implementations of the method 2300 include transmitting a parameter (such as parameter 710 in FIG. 7) to a machine learning predictive analytic engine (such as the machine learning predictive analytic engine 150 in FIG. 7), at block 2310.

Some implementations of the method 2300 include generating a set of predictions (such as the predictions 160 in FIG. 7) by machine learning predictive analytic engine (such as by machine learning predictive analytic engine 150 in FIG. 7) in reference to the machine learning trained model (such as the machine learning trained model 130 in FIG. 1) and the parameter (such as parameter 710 in FIG. 7), at block 2320.

Some implementations of the method 2300 include storing the set of predictions (such as the predictions 160 in FIG. 7) to a memory (such as memory 220 in FIG. 7), at block 2330.

Some implementations of the method 2300 include transmitting the set of predictions (such as the predictions 160 in FIG. 7) to the second computer (such as second computer 310 in FIG. 7), at block 2340.

FIG. 24 is a flowchart of a method 2400 of generating and storing a prediction according to an implementation of FIG. 8 in reference to new data and from training data that describes representations of issues of interest of the entities that are in common with training data that describes one or more contributions of resources. Method 2400 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2400 provides predictive analytics on the training data, by a machine learning predictive analytic engine, and generates predictions accordingly. The predictive analytic control computer is a first computer in apparatus 800.

Some implementations of the method 2400 include receiving a first training profile data (such as training profile data 320 in FIG. 8) from a second computer (such as second computer 310 in FIG. 8), at block 1905.

Some implementations of the method 2400 include storing the first training profile data into a memory (such as memory 210), at block 1910.

Some implementations of the method 2400 include storing the first training profile data in a training profile data (such as the training profile data 110 in FIG. 8), at block 1915.

Some implementations of the method 2400 include receiving a second training profile data (such as training profile data 320 in FIG. 8) from a second computer (such as second computer 340 in FIG. 8), at block 1920.

Some implementations of the method 2400 include storing the second training profile data into a memory (such as memory 210), at block 1925.

Some implementations of the method 2400 include storing the second training profile data in a training profile data (such as the training profile data 110 in FIG. 8), at block 1930.

Some implementations of the method 2400 include transmitting the training profile data to a learning predictive analytic trainer (such as the learning predictive analytic trainer 120 in FIG. 8) that produces a machine learning trained model (such as the machine learning trained model 130 in FIG. 8) from the training profile data, at block 1935.

Some implementations of the method 2400 include transmitting a parameter (such as parameter 810 in FIG. 8) to a machine learning predictive analytic engine (such as the machine learning predictive analytic engine 150 in FIG. 8), at block 2410.

Some implementations of the method 2400 include generating a set of predictions (such as the predictions 160 in FIG. 8) by machine learning predictive analytic engine (such as by machine learning predictive analytic engine 150 in FIG. 8) in reference to the machine learning trained model (such as the machine learning trained model 130 in FIG. 1) and the parameter (such as parameter 810 in FIG. 8), at block 2420.

Some implementations of the method 2400 include storing the set of predictions (such as the predictions 160 in FIG. 8) to a memory (such as memory 220 in FIG. 8), at block 2430.

Some implementations of the method 2400 include transmitting the set of predictions (such as the predictions 160 in FIG. 8) to the second computer (such as second computer 310 in FIG. 8), at block 2440.

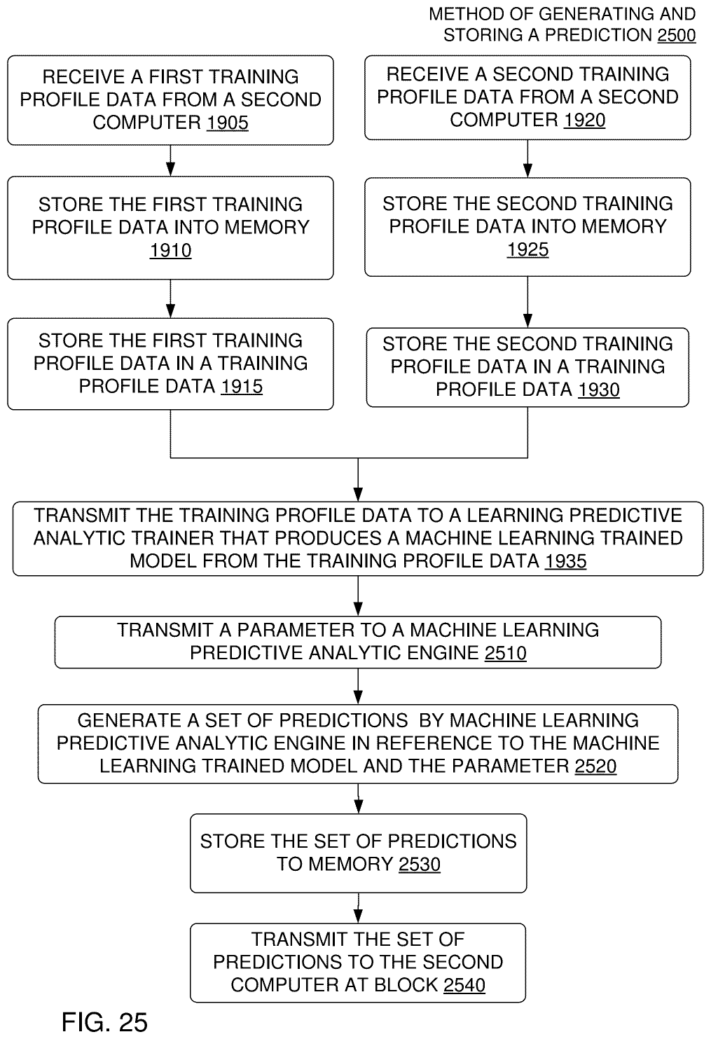

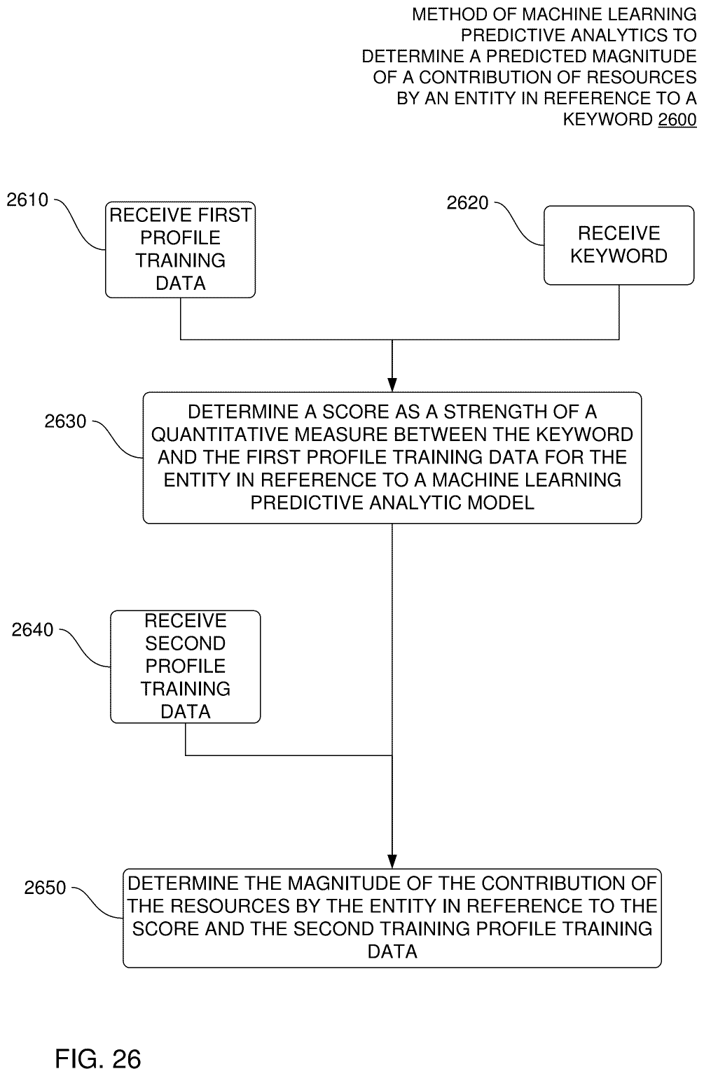

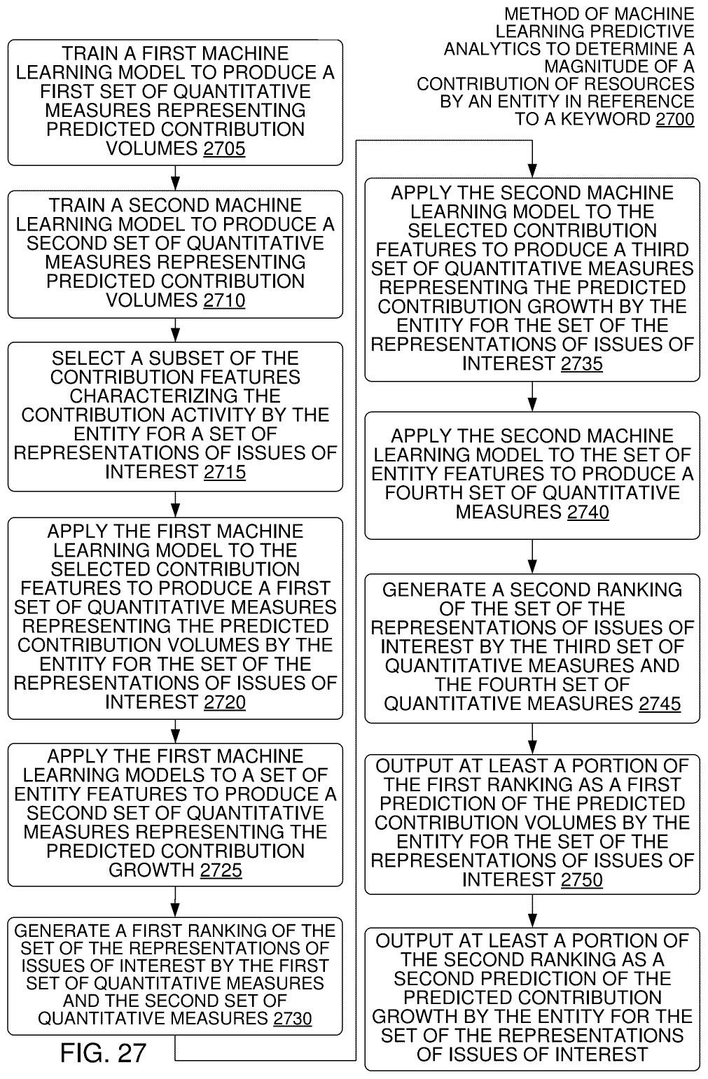

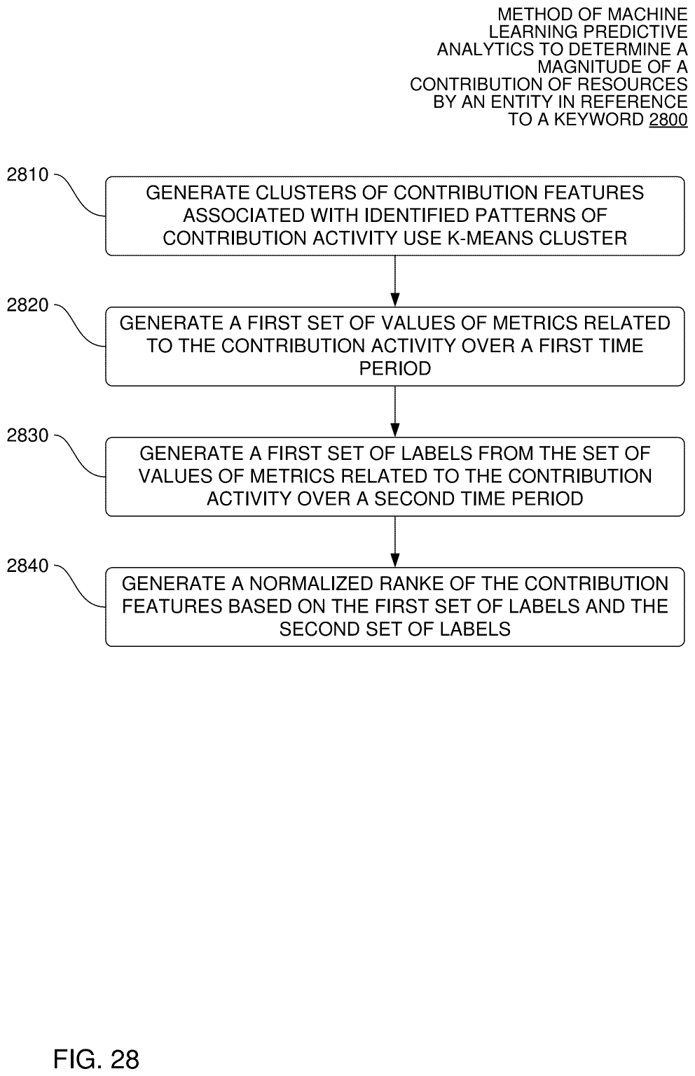

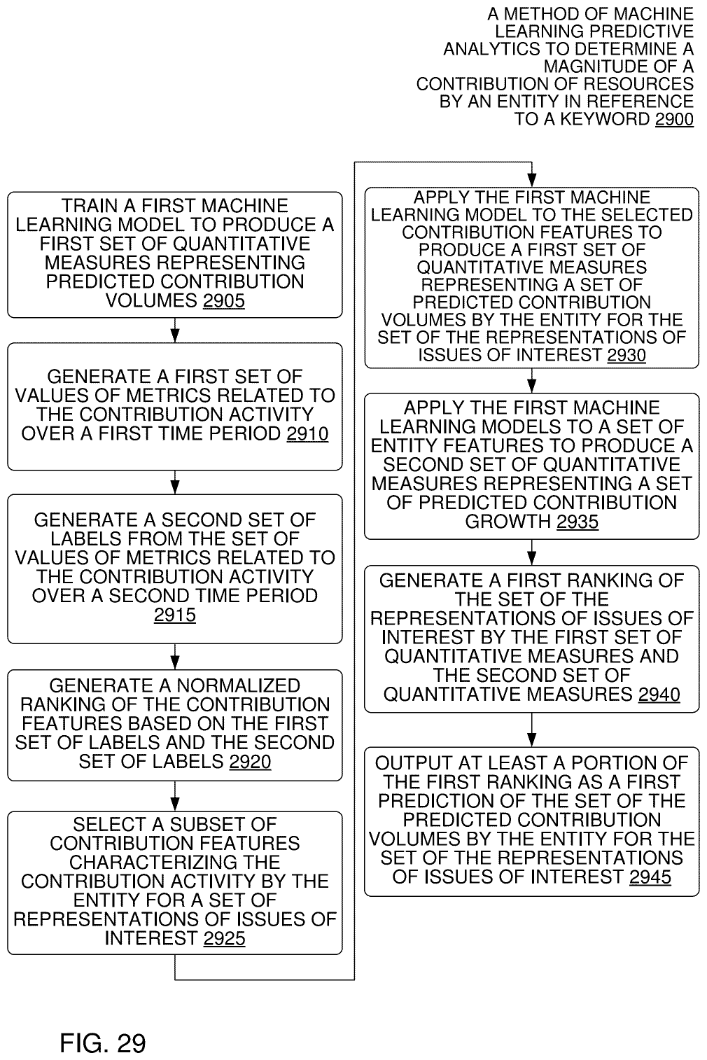

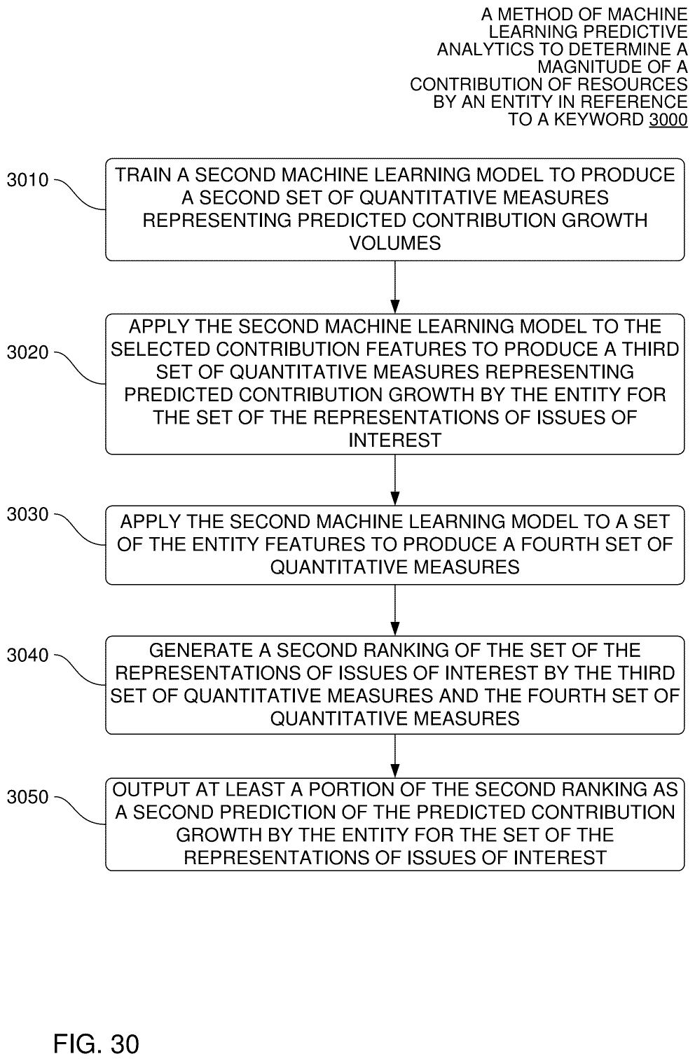

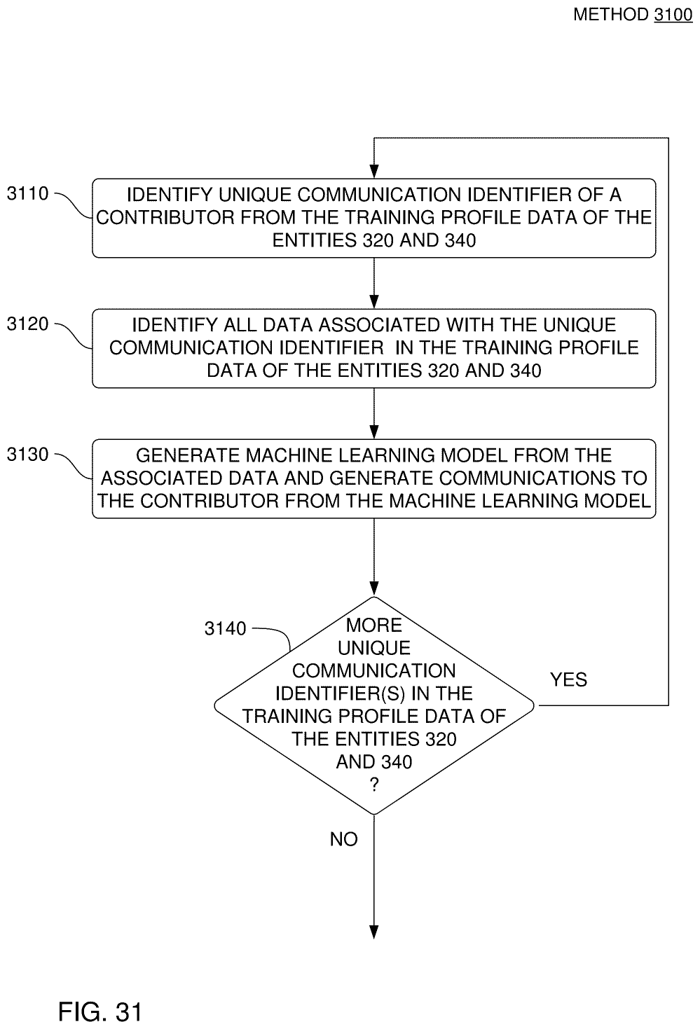

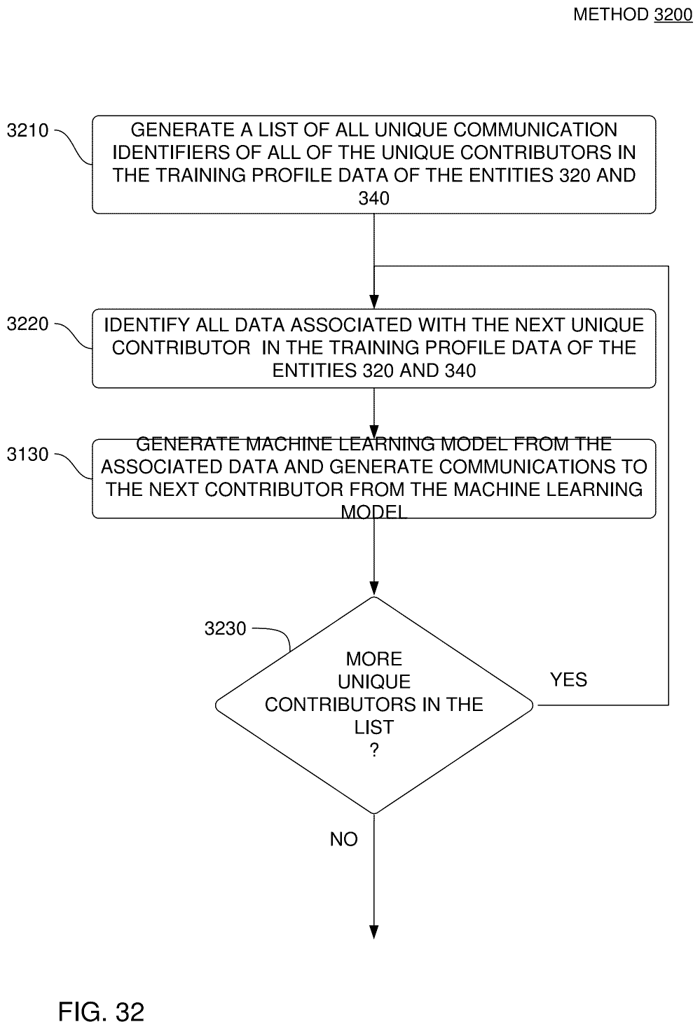

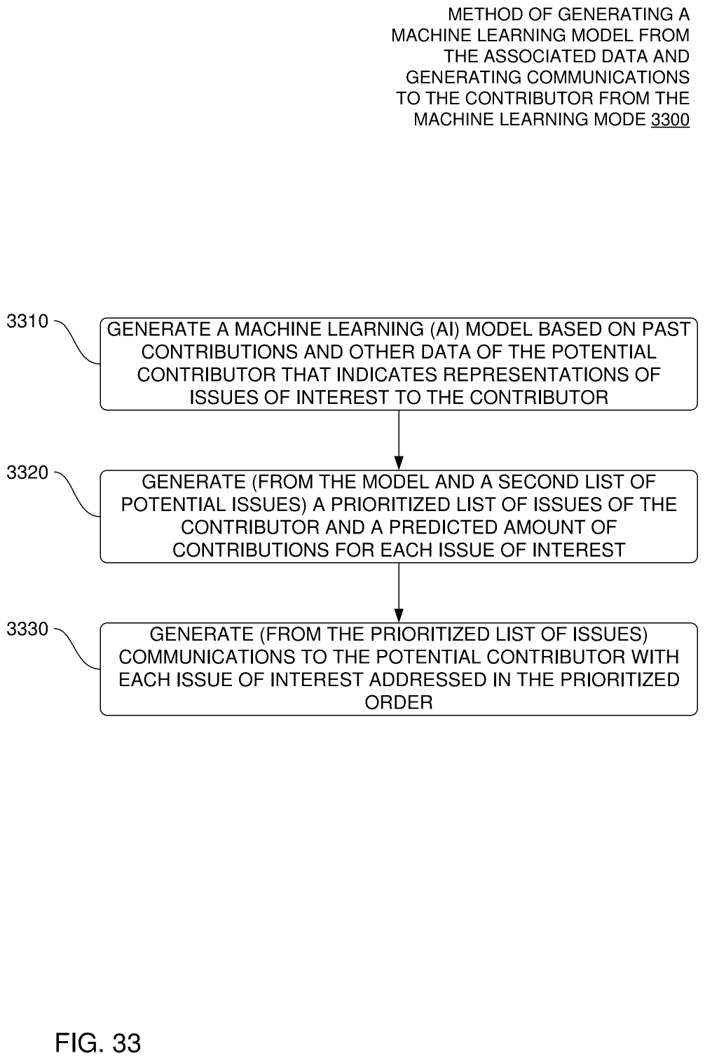

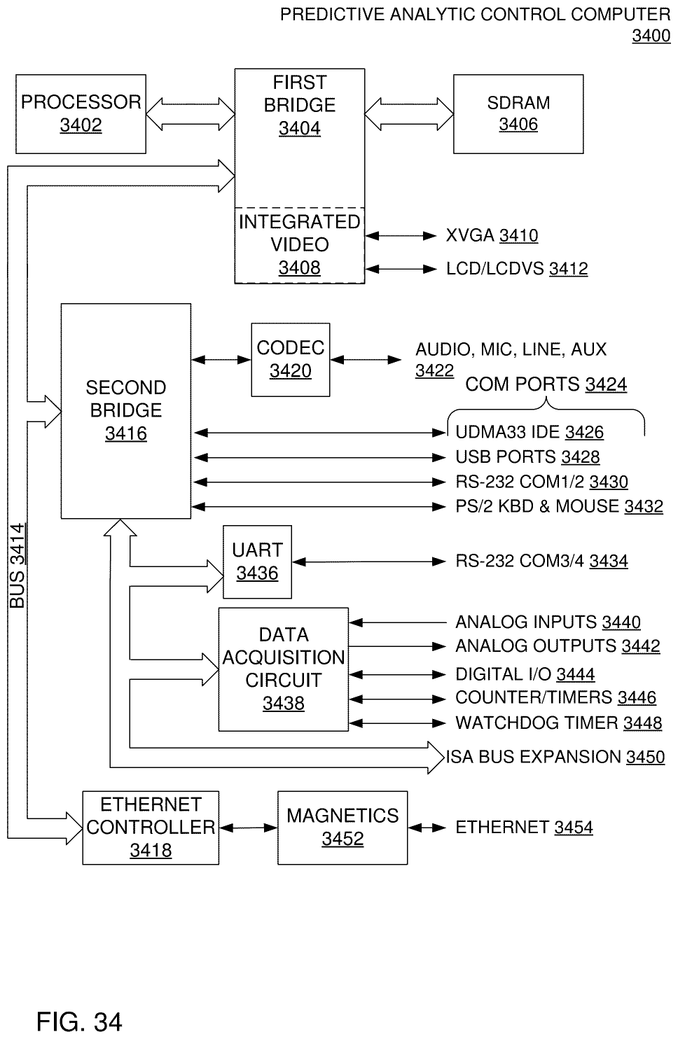

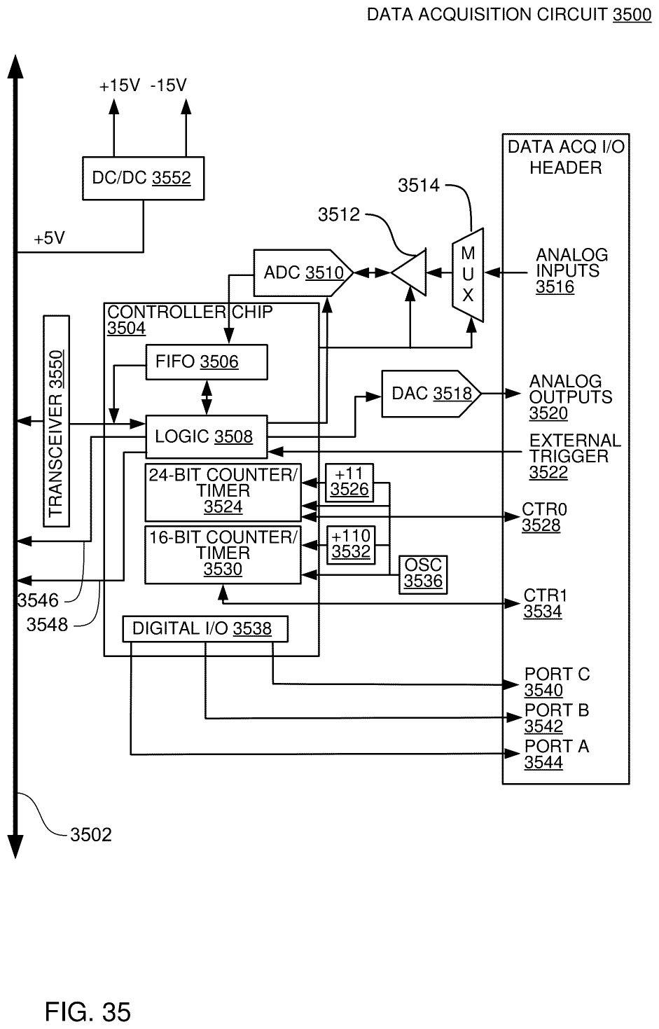

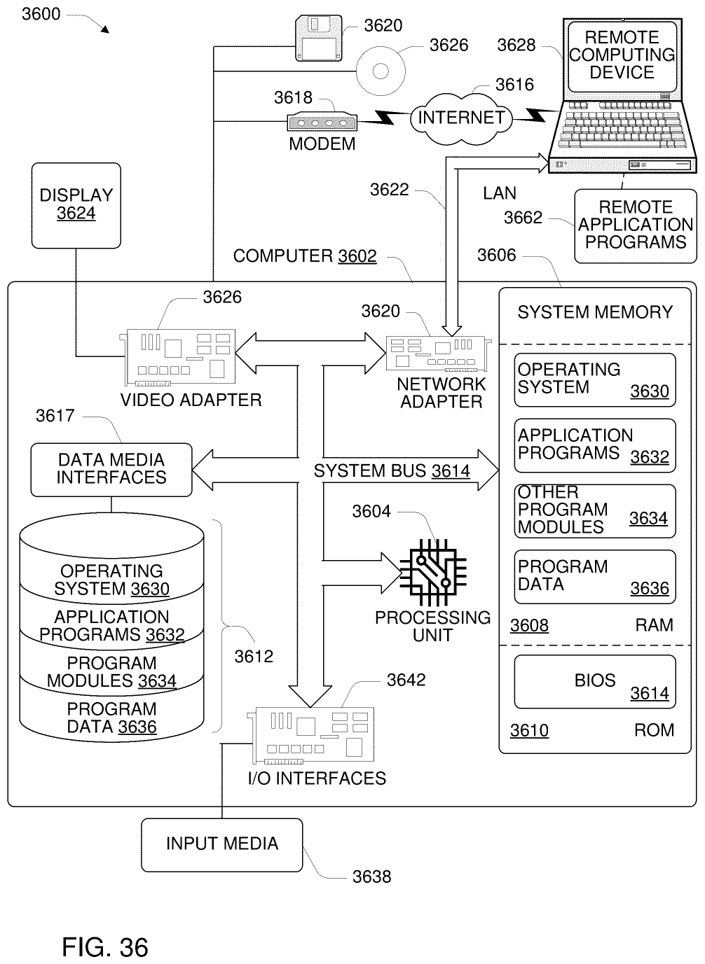

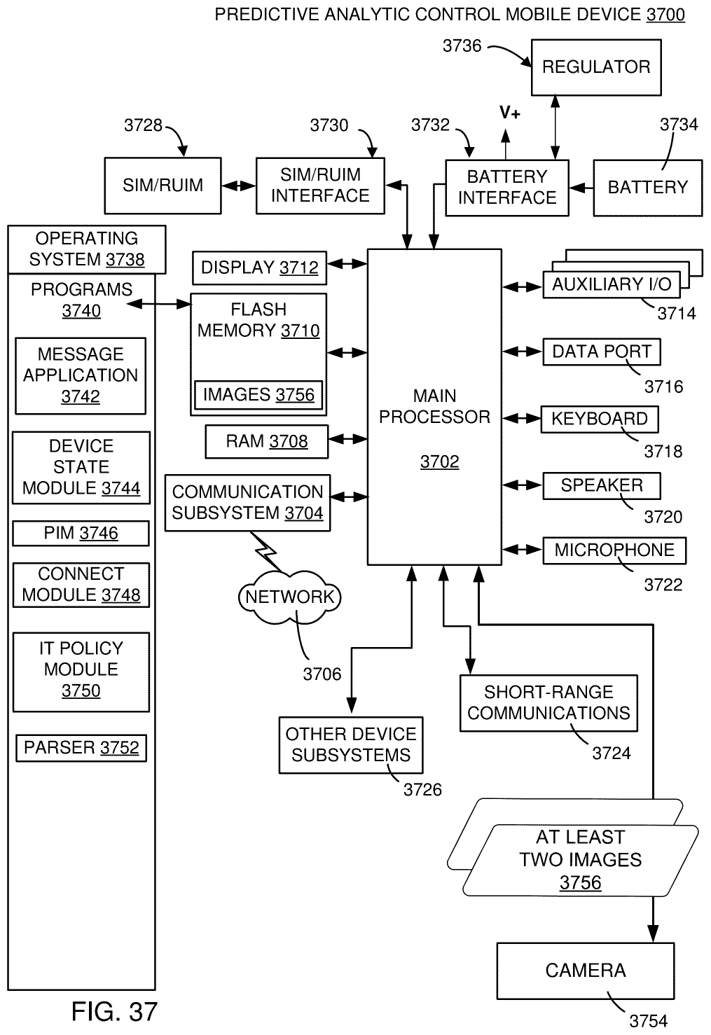

FIG. 25 is a flowchart of a method 2500 of generating and storing a prediction according to an implementation of FIG. 9 in reference to new data and from training data that describes representations of issues of interest of the entities that are not in common with training data that describes one or more contributions of resources. Method 2500 is performed by a predictive analytic control computer that includes a machine learning predictive analytic trainer, such as machine learning predictive analytic trainer 120 and a machine learning predictive analytic engine, such as machine learning predictive analytic engine 150, according to an implementation. Method 2500 provides predictive analytics on the training data, by a machine learning predictive analytic engine, and generates predictions accordingly. The predictive analytic control computer is a first computer in apparatus 900.

Some implementations of the method 2500 include receiving a first training profile data (such as training profile data 320 in FIG. 9) from a second computer (such as second computer 310 in FIG. 9), at block 1905.

Some implementations of the method 2500 include storing the first training profile data into a memory (such as memory 210), at block 1910.

Some implementations of the method 2500 include storing the first training profile data in a training profile data (such as the training profile data 110 in FIG. 9), at block 1915.

Some implementations of the method 2500 include receiving a second training profile data (such as training profile data 320 in FIG. 9) from a second computer (such as second computer 340 in FIG. 9), at block 1920.

Some implementations of the method 2500 include storing the second training profile data into a memory (such as memory 210), at block 1925.

Some implementations of the method 2500 include storing the second training profile data in a training profile data (such as the training profile data 110 in FIG. 9), at block 1930.

Some implementations of the method 2500 include transmitting the training profile data to a learning predictive analytic trainer (such as the learning predictive analytic trainer 120 in FIG. 9) that produces a machine learning trained model (such as the machine learning trained model 130 in FIG. 9) from the training profile data, at block 1935.

Some implementations of the method 2500 include transmitting a parameter (such as parameter 710 in FIG. 9) to a machine learning predictive analytic engine (such as the machine learning predictive analytic engine 150 in FIG. 9), at block 2510.

Some implementations of the method 2500 include generating a set of predictions (such as the predictions 160 in FIG. 9) by machine learning predictive analytic engine (such as by machine learning predictive analytic engine 150 in FIG. 9) in reference to the machine learning trained model (such as the machine learning trained model 130 in FIG. 1) and the parameter (such as parameter 910 in FIG. 9), at block 2520.

Some implementations of the method 2500 include storing the set of predictions (such as the predictions 160 in FIG. 9) to a memory (such as memory 220 in FIG. 9), at block 2530.

Some implementations of the method 2500 include transmitting the set of predictions (such as the predictions 160 in FIG. 9) to the second computer (such as second computer 310 in FIG. 9), at block 2540.

FIG. 26 is a flowchart of a method 2600 of machine learning predictive analytics to determine a magnitude of a contribution of resources by an entity in reference to a keyword, the method performed by a microprocessor in a predictive analytic control computer.

The method 2600 includes, at block 2610, receiving a first training profile data. In some implementations, the first training profile data is associated only with the entity. One example of the first training profile data is item 320 in FIG. 3. In some implementations, the first training profile data is associated with a plurality of unique entities, and as in item 320 in FIG. 1, is text data that describes community-based input, interaction, content-sharing and collaboration of the entities that describes features and representations of issues of interest of the entities.

The method 2600 includes, at block 2620, receiving a keyword. Examples of the keyword include the parameter 140 in FIG. 1-3, the item 410 in FIG. 4, the item 510 in FIG. 5, the item 610 in FIG. 6, the item 710 in FIG. 7, the item 810 in FIG. 8 or the item 910 in FIG. 9.

In some implementations, method 2600 includes at block 2630, determining a score as a strength of a quantitative measure between the keyword and the first training profile data for the entity, or in some implementations, block 140 includes determining a score as a strength of a quantitative measure between the keyword and the first training profile data for a plurality of entities. The determining 2640 is performed by a machine learning predictive analytic engine (such as the machine learning predictive analytic engine 150 in FIG. 1-9) in reference to a machine learning predictive analytic model (such as the machine learning predictive analytic model 130 in FIGS. 1-9) that is trained on the first training profile data. The first training profile data is associated with a plurality of unique entities, the first training profile data describing a community-based input, interaction, content-sharing and collaboration that describes features and representations of issues of interest of the entity, wherein a portion of the first training profile data is associated with the entity. In some implementations.

The method 2600 includes, at block 2640, receiving a second profile data. In some implementations, the second profile data is associated only with the entity, and as in item 340 in FIG. 1, is text data that describes one or more contributions of resources that is/are associated and identified with the entity only. In some implementations, the second profile data is associated with a plurality of unique entities, and as in item 340 in FIG. 1, is text data that one or more contributions of resources that is/are associated and identified with the entities.

In some implementations, method 2600 includes, at block 2650, determining the magnitude of the contribution of the resources by the entity in reference to the score and the second training profile data (such as in item 340 in FIG. 1). In some implementations, block 2650 includes determining the magnitude of the contribution of the resources by the entities in reference to the score and the second training profile data.

In some implementation of method 2600, the first training profile data is first profile data which has not been cleaned yet, in which case, the method 2600 also includes the step of cleaning the first profile data to become the first training profile data.

FIG. 27 is a flowchart of a method 2700 of machine learning predictive analytics to determine a magnitude of a contribution of resources by an entity in reference to a keyword, the method performed by a microprocessor in a predictive analytic control computer.

The method 2700 includes, at block 2705, with training data relating to previous activity of the contribution of the resources of a plurality of entities, training a first machine learning model to produce a first set of quantitative measures representing a set of first predicted contribution amounts, at block 2705.

The method 2700 includes, at block 2710, with training data relating to previous activity of the contribution of the resources of the plurality of entities, training a second machine learning model to produce a second set of quantitative measures representing a set of second predicted contribution growth, at block 2710. Method 2800 is one implementation of action 2710.

The method 2700 includes, at block 2715, selecting a subset of the contribution features characterizing the contribution activity by the entity for a set of representations of issues of interest. The selecting 2715 is performed from the normalized ranking of the subset of the contribution features, yielding selected contribution features.

In some implementations, the method 2700 also includes, at block 2720, applying the first machine learning model to the selected contribution features to produce a first set of quantitative measures representing the predicted contribution amounts by the entity for the set of the representations of issues of interest.

In some implementations, the method 2700 also includes, at block 2725, applying the first machine learning models to a set of entity features to produce a second set of quantitative measures representing the predicted contribution growth.

In some implementations, the method 2700 also includes, at block 2730, generating a first ranking of the set of the representations of issues of interest by the first set of quantitative measures and the second set of quantitative measures.

In some implementations, the method 2700 also includes, at block 2735, applying the second machine learning model to the selected contribution features to produce a third set of quantitative measures representing the predicted contribution growth by the entity for the set of the representations of issues of interest.

In some implementations, the method 2700 also includes, at block 2740, applying the second machine learning model to the set of entity features to produce a fourth set of quantitative measures.

In some implementations, the method 2700 also includes, at block 2745, generating a second ranking of the set of the representations of issues of interest by the third set of quantitative measures and the fourth set of quantitative measures.

In some implementations, the method 2700 also includes, at block 2750, outputting at least a portion of the first ranking as a first prediction of the predicted contribution amounts by the entity for the set of the representations of issues of interest.

In some implementations, the method 2700 also includes, at block 2755, outputting at least a portion of the second ranking as a second prediction of the predicted contribution growth by the entity for the set of the representations of issues of interest.

FIG. 28 is a flowchart of a method 2800 of training a machine learning model to produce a set of quantitative measures representing a predicted contribution growth, the method performed by a microprocessor in a predictive analytic control computer. Method 2800 is one implementation of actions 2705 and 2710 in FIG. 27.

In some implementations, method 2800 includes, at block 2810, generating clusters of contribution features associated with identified patterns of contribution activity using k-means clustering.

In some implementations, method 2800 also includes, at block 2820, generating a first set of values of metrics related to the contribution activity over a first time period.

In some implementations, method 2800 also includes, at block 2830, generating a first set of labels from the set of values of metrics related to the contribution activity over a second time period.

In some implementations, the method 2800 also includes, at block 2840, generating a normalized ranking of the contribution features based on the first set of labels and the second set of labels.

FIG. 29 is a flowchart of a method 2900 of machine learning predictive analytics to determine a magnitude of a contribution of resources by an entity in reference to a keyword, the method performed by a microprocessor in a predictive analytic control computer, according to an implementation.

In some implementations, the method 2900 includes, at block 2905, with training data relating to previous activity of contribution of the resources of a plurality of entities, training a first machine learning model to produce a first set of quantitative measures representing predicted contribution amounts. In some implementations, the training further includes generating clusters of contribution features associated with identified patterns of contribution activity using k-means clustering.

In some implementations, the method 2900 also includes, at block 2910, generating a first set of values of metrics related to the contribution activity over a first time period.

In some implementations, the method 2900 also includes, at block 2915, generating a second set of labels from the set of values of metrics related to the contribution activity over a second time period.

In some implementations, the method 2900 also includes, at block 2920, generating a normalized ranking of the contribution features based on the first set of labels and the second set of labels.

In some implementations, the method 2900 also includes, at block 2925, selecting a subset of contribution features characterizing the contribution activity by the entity for a set of representations of issues of interest. In some implementations, the selecting is performed from the normalized ranking of the subset of contribution features, yielding selected contribution features.

In some implementations, the method 2900 also includes, at block 2930, applying the first machine learning model to the selected contribution features to produce a first set of quantitative measures representing a set of predicted contribution amounts by the entity for the set of the representations of issues of interest.

In some implementations, the method 2900 also includes, at block 2935, applying the first machine learning models to a set of entity features to produce a second set of quantitative measures representing a set of predicted contribution growth.

In some implementations, the method 2900 also includes, at block 2940, generating a first ranking of the set of the representations of issues of interest by the first set of quantitative measures and the second set of quantitative measures.

In some implementations, the method 2900 also includes, at block 2945, outputting at least a portion of the first ranking as a first prediction of the set of the predicted contribution amounts by the entity for the set of the representations of issues of interest.

In some implementations of the methods 2700, 2800 and 2900 in FIG. 27-29, the set of the entity features include at least one of an identifier (SSN) of the entity, a name of the entity, a net worth of the entity, an age of the entity, a gender of the entity, a work title of the entity, an industry of the entity, a location zip code. In some implementations of the methods 2700, 2800 and 2900 in FIG. 27-29, the contribution features include at least one of a contribution date, a contribution amount, a donee name.

FIG. 30 is a flowchart of a method 3000 of machine learning predictive analytics to determine a magnitude of a contribution of resources by an entity in reference to a keyword, the method performed by a microprocessor in a predictive analytic control computer, according to an implementation. Method 3000 is an implementation of further actions to method 3000 in FIG. 30.

In some implementations, the method 3000 also includes, at block 3010, with the training data relating to the previous activity of the contribution of resources of the plurality of entities, training a second machine learning model to produce a second set of quantitative measures representing predicted contribution growth amounts.

In some implementations, the method 3000 also includes, at block 3020, applying the second machine learning model to the selected contribution features to produce a third set of quantitative measures representing predicted contribution growth by the entity for the set of the representations of issues of interest.

In some implementations, the method 3000 also includes, at block 3030, applying the second machine learning model to a set of the entity features to produce a fourth set of quantitative measures.

In some implementations, the method 3000 also includes, at block 3040, generating, by the one or more computer systems, a second ranking of the set of the representations of issues of interest by the third set of quantitative measures and the fourth set of quantitative measures.

In some implementations, the method 3000 also includes, at block 3050, outputting at least a portion of the second ranking as a second prediction of the predicted contribution growth by the entity for the set of the representations of issues of interest.

FIG. 31 is a flow chart of a method 3100 of machine learning predictive analytics to generate communications to contributors, according to an implementation. FIG. 31 includes, at block 3110, identifying a unique communication identifier of a contributor from the training profile data of the entities. Examples of the training profile data is training profile data 320 and training profile data 340 in FIG. 3-9. Examples of a communication identifier is an email address, a facebook ID and an “X” ID.

Method 3100 also includes, at block 3120, Identifying all data associated with the Unique communication identifier of the contributor in the training profile data of the entities 320 and 340.

Method 3100 also includes, at block 3130, generating a machine learning model from the associated data and generating communications to the contributor from the machine learning model. One implementation of block 3130 is method 3300 in FIG. 33.

Method 3100 also includes, at block 3140, determining whether or not additional unique communication identifier(s) exist in the training profile data of the entities 320 and 340. If additional unique communication identifier(s) exist in the training profile data of the entities 320 and 340, then the method continues at block 3110. If no additional unique communication identifier(s) exist in the training profile data of the entities 320 and 340, then the method 3100 ends.

FIG. 32 is a flow chart of a method 3200 of machine learning predictive analytics to generate communications to contributors, according to an implementation. FIG. 32 includes, at block 3210, generating a list of all unique communication identifiers of all of the unique contributors in the training profile data of the entities 320 and 340. Examples of the training profile data is training profile data 320 and training profile data 340 in FIG. 3-9. Examples of a communication identifier is an email address, a facebook ID and an “X” ID.

Method 3200 also includes, at block 3220, identifying all data associated with the next unique contributor in the training profile data of the entities 320 and 340.

Method 3200 also includes, at block 3130, generating a machine learning model from the associated data and generating communications to the contributor from the machine learning model. One implementation of block 3130 is method 3300 in FIG. 33.

Method 3200 also includes, at block 3230, determining whether or not more unique contributors exist in the list. If more unique contributors exist in the list, then the method continues at block 3210. If no more unique contributors exist in the list, then the method 3200 ends.

FIG. 33 is a flowchart of a method 3300 of generating a machine learning model from the associated data and generating communications to the contributor from the machine learning model, according to an implementation. Method 3300 is an implementation of block 3130 in FIG. 31 and FIG. 32. Method 3300 is performed for each potential contributor entity.

In some implementations, method 3300 includes, at block 3310, generating a machine learning model based on past contributions and other data of the potential contributor that indicates representations of issues of interest to the contributor.

In some implementations, method 3300 includes, at block 3320, generating (from the model and a second list of potential issues) a prioritized list of issues of the contributor and a predicted amount of contributions for each issue of interest.

In some implementations, method 3300 includes, at block 3330, generating (from the prioritized list of issues) communications to the potential contributor with each issue of interest addressed in the prioritized order.

In some implementations, the predictions in FIG. 1-33 (e.g. predictions 160) describe an expected contribution of resources of the entities in regards to a particular representation of issue of interest. For example, the predictions describe the expected extent that the entities will contribute resources in regards to the issue of curing cancer. The expected extent of contributions of resources can be a quantitative measure.

The quantitative measure of the expected extent of contributions of resources can be a score on a scale of 1 to 10, or the expected extent of contributions of resources can be an amount measured in a monetary currency.

In some implementations, the contributions of resources are contributions of resources to a donee (such as a 501(c)(3) organization) or a candidate for elected office.

In some implementations, methods 1900-2500 are implemented as a sequence of instructions which, when executed by a processor, such as processor 3402 in FIG. 34, processing unit 3604 in FIG. 36 and main processor 3702 in FIG. 37, cause the processor to perform the respective method. In other implementations, methods 1900-2500 are implemented as a computer-accessible medium having executable instructions capable of directing a processor, such as processor 3402 in FIG. 34, processing unit 3604 in FIG. 36 and main processor 3702 in FIG. 37, to perform the respective method. In varying implementations, the medium is a magnetic medium, an electronic medium, or an optical medium.

In some implementations of method 1900, the new data in FIG. 1-19 (item 140 in FIG. 1-3) are one or more words, or keywords, describing one of more particular representations of issues of interest, such as a cure for cancer. In some implementation the purpose, goal and output of the systems, apparatus and methods described is a measure of the expected contributions of resources that the entities will make in regards to each of the issues described by the new data.

In some implementations of FIG. 1-33, the parameter 140 in FIG. 1-3, the item 140 in FIG. 3, the item 410 in FIG. 4, the item 510 in FIG. 5, the item 610 in FIG. 6, the item 710 in FIG. 7, the item 810 in FIG. 8 or the item 910 in FIG. 9 are a second set of features and representations of issues of interest.

### Machine Learning Processes

The machine learning predictive analytic trainer 120 in FIG. 1-3 can be implemented using a number of different machine learning processes as described below.

Machine learning is a subset of artificial intelligence that can learn from and make decisions and predictions based on data over time in response to the addition of new data and new results, in comparison to traditional systems that are relatively inflexibly designed to always provide a predetermined result from a specific set of data.

A machine learning system is a data-driven system rather than an algorithmic-based system. A machine learning system trains on a pre-defined data-set. Before training, the data is unlabeled or uncategorized.

There are four different categories for machine learning processes: Supervised learning, Unsupervised Learning, Semi-supervised learning and Reinforcement-Based Learning.

Supervised training is task driven to predict the next value that uses mapping between input and output, where the feedback provided to the agent is a correct set of actions for performing a task. In supervised learning, processes learn from labeled data using the supervised learning method in machine learning. This process involves the process receiving input data and the appropriate output labels. The goal is to teach the process to correctly predict labels for brand-new, untainted data. Processes like Decision Trees, Support Vector Machines, Random Forests, and Naive Bayes are examples of supervised learning processes. These processes can be applied to classification, regression, and time series forecasting tasks. In order to make predictions and derive useful insights from data, supervised learning is widely used in a variety of industries, including healthcare, finance, marketing, and image recognition.

Unsupervised training is data driven in order to identify clusters of data that have commonalities by automatically finding patterns and relationships in the dataset with no prior knowledge of the dataset or no prior training on the dataset. In Unsupervised learning, processes analyze unlabeled data in this machine learning method without using predetermined output labels. Finding patterns, relationships, or structures within the data is the aim. Unsupervised learning processes, in contrast to supervised learning, operate autonomously to unearth secret information and combine related data points. Clustering processes like K-means, hierarchical clustering, and DBSCAN, as well as dimensionality reduction techniques like PCA and t-SNE, are examples of popular unsupervised learning techniques.

Semi-supervised learning is a hybrid approach to machine learning that uses both labeled and unlabeled data for training. In order to enhance learning, it makes use of both a larger set of unlabeled data and a smaller amount of labeled data. The unlabeled data are supposed to offer extra context and information to improve the model's comprehension and functionality. Semi-supervised learning can get around the drawbacks of only using labeled data by effectively utilizing the unlabeled data. This strategy is especially helpful when getting labeled data requires a lot of resources or processing power.

In reinforcement-based learning, a machine learning process called reinforcement learning is developed in part as a reference to how people learn by making mistakes. In this scenario, an agent interacts with the environment and learns to choose the best course of action to maximize cumulative rewards. Based on its actions, the agent receives feedback in the form of rewards or penalties. Over time, the agent develops the ability to make decisions that produce the best results. Reinforcement-based learning makes it possible for machines to use a series of actions to accomplish long-term objectives, adapt to changing environments, and learn from their experiences. Reinforcement-based learning is an effective method for addressing challenging decision-making issues thanks to its dynamic learning approach. Reinforcement-based learning uses mapping between input and output and uses rewards and punishments as signals for positive and negative behavior. Reinforcement-based learning was pioneered by Richard Sutton. Examples of reinforcement learning include Q-learning that uses:

$$Q ( s \text{?} , a \text{?} ) ← ( 1 - α ) \cdot {\underbrace{Q ( s \text{?} , a \text{?} )}}_{old value} + {{\underbrace{α}}_{learning rate} \cdot \overbrace{( {\underbrace{r \text{?}}}_{reward} + {\underbrace{γ}}_{discount factor} \cdot {\underbrace{{max}_{α} Q ( s \text{?} , a )}}_{estimate of optimal future value} )}}^{learned value}$$

$$\text{?} \text{indicates text missing or illegible when filed}$$

and SARSA (State-Action-Reward-State-Action) model tuning, in which all model weights are tuned, can be fine-tuned to adapt a machine learning trained model to new downstream tasks without retraining the entire machine learning trained model, such as by prefix tuning, which can be simplified as prompt tuning.

These four machine learning process categories are further divided into additional categories. These are the most popular supervised machine learning processes: decision tree, gradient boosting process and AdaBoosting process, KNN process, linear regression, logistic regression, Naive Bayes process, random forest process and SVM process. Unsupervised machine learning processes include K-means process.

Decision Tree. In a decision Tree process, in which a supervised learning process is used for problem classification, is one of the most widely used processes in machine learning. It does a good job of categorizing both categorical and continuous dependent variables. The population is split into two or more homogeneous sets using this process, depending on the most important features or independent variables.

Gradient boosting process and AdaBoosting process: These processes are used when massive loads of data have to be handled to make predictions with high accuracy. Boosting is an ensemble learning algorithm that combines the predictive power of several base estimators to improve robustness. In short, it combines multiple weak or average predictors to build a strong predictor.

KNN (K-Nearest Neighbors) process. In KNN, both classification and regression issues can be solved using this process. In KNN, a process that classifies any new cases by obtaining a majority vote from its k neighbors and then stores all of the existing cases. The class with which the case has the most in common is then given the assignment. This calculation is made using a distance function. The following factors should be taken into account before choosing the K Nearest Neighbors process. KNN requires a lot of computation resources. Normalizing variables is necessary to prevent process bias from higher range variables. Processing of the prior data is still required.

Linear regression process: By fitting the independent and dependent variables to a line, a relationship between them can be found in this process. The equation Y=a*X+b, also known as the regression line, describes this line. The sum of the squared distance differences between the data points and the regression line is minimized to obtain the coefficients a and b.

This equation reads as follows.
Y is the dependent variable.
Slope is a.
X is an unrelated variable.

Logistic Regression. Discrete values (typically binary values like 0/1) are estimated from a set of independent variables using logistic regression. By adjusting the data to a logic function, it aids in predicting the likelihood of an event. Additionally known as logic regression.

The Naive Bayes process. An assumption made by a Naive Bayes classifier is that the presence of one feature in a class has no bearing on the presence of any other features. When determining the likelihood of a specific result, a Naive Bayes classifier would take into account each of these features independently, even if these features are related to one another. Large datasets can benefit from using a Naive Bayesian model, which is simple to construct. It is known to perform better than even the most sophisticated classification techniques despite being simple.

Random Forests Process: A Random Forest is an arrangement of decision trees. Each tree is assigned a class and “votes” for that class in order to categorize a new object according to its attributes. Over all of the trees in the forest, the classification with the most votes is chosen by the forest.

The planting and growth of each tree is done as follows: If the training set contains N cases, then a random sample of N cases is selected. For growing the tree, this sample will serve as the training set.

If M input variables are present, then m.

The SVM process (Support Vector Machine): Plotting raw data as points in an n-dimensional space (where n is the number of features you have) is a technique used in the SVM process, a classification process. After that, each feature's value is associated with a specific coordinate, which facilitates the data's classification. The data can be divided into groups and plotted on a graph using lines known as classifiers.

K-Means. In K-means a process manages clustering issues by using unsupervised learning. Data sets are divided into a certain number of clusters (e.g. number K) in such a way that all the data points within a cluster are homogenous and heterogeneous from the data in other clusters. K-means creates clusters in the following ways: The K-means process selects k centroids, or points, for each cluster. With the closest centroids, each data point creates a cluster, i.e. clusters of K. From the current cluster members, it now generates new centroids. The closest distance for every data point is calculated using these new centroids. Up until the centroids stay the same, this process is repeated.

### Hardware and Operating Environment

FIG. 34 is a block diagram of a predictive analytic control computer 3400, according to an implementation. The predictive analytic control computer 3400 includes a processor 3402 (such as a Pentium III processor from Intel Corp. in this example) which includes dynamic and static ram and non-volatile program read-only-memory (not shown), operating memory 3404 (SDRAM in this example), communication ports 3406 (e.g., RS-232 COM1/2 3408 or Ethernet 3410), a data acquisition circuit 3412 with analog inputs 3414, analog output 3416 and digital I/O port(s) 3418.

In some implementations of the predictive analytic control computer 3400, the processor 3402 and the operating memory 3404 are coupled through a bridge 3420. In some implementations of the predictive analytic control computer 3400, the bridge 3420 includes a video port 3424 having display outputs 3426 and LCD 3428.

In some implementations of the predictive analytic control computer 3400, the communication ports 3406 are coupled through a bridge 3430 and a bus 3422 to the bridge 3420. In some implementations of the predictive analytic control computer 3400, communication port 3406 also includes an integrated drive electronics (IDE) port 3432 such as an ultra direct memory access 33 (UDMA33) port, and universal serial bus (USB) ports 3434, and a PS/2 keyboard and mouse port 3436. In some implementations of the predictive analytic control computer 3400, a port 3438 for audio, microphone, line and auxiliary devices is coupled through a coder/decoder (CODEC) 3440 to the bridge 3430.

In some implementations of the predictive analytic control computer 3400, the data acquisition circuit 3412 is also coupled to counter/timer ports 3442 and watchdog timer ports 3444. In some implementations of the predictive analytic control computer 3400, an RS-232 port 3446 is coupled through a universal asynchronous receiver/transmitter (UART) 3448 to the bridge 3430.

In some implementations of the predictive analytic control computer 3400, an industry standard architecture (ISA) bus expansion port 3450 is coupled to the bridge 3430. In some implementations of the predictive analytic control computer 3400, the Ethernet port 3410 is coupled to the bus 3422 through an Ethernet controller 3452 and a magnetics 3454.

FIG. 35 is a block diagram of a data acquisition circuit 3500 of a predictive analytic control computer, according to an implementation. The data acquisition circuit 3500 is one example of the data acquisition circuit 3412 in FIG. 34 above. Some implementations of the data acquisition circuit 3500 provide 16-bit A/D performance with input voltage capability up to +/−10V, and programmable input ranges.

The data acquisition circuit 3500 includes a bus 3502, such as a conventional PC/104 bus. The data acquisition circuit 3500 is operably coupled to a controller chip 3504. Some implementations of the controller chip 3504 include an analog/digital first-in/first-out (FIFO) buffer 3506 that is operably coupled to controller logic 3508. In some implementations of the data acquisition circuit 3500, the FIFO 3506 receives signal data from and analog/digital converter (ADC) 3510, which exchanges signal data with a programmable gain amplifier 3512, which receives data from a multiplexer 3514, which receives signal data from analog inputs 3516.

In some implementations of the data acquisition circuit 3500, the controller logic 3508 sends signal data to the ADC 3510 and a digital/analog converter (DAC) 3518. The DAC 3518 sends signal data to analog outputs 3520. In some implementations of the data acquisition circuit 3500, the controller logic 3508 receives signal data from an external trigger 3522.

In some implementations of the data acquisition circuit 3500, the controller chip 3504 includes a 24-bit counter/timer 3524 that receives signal data from a +10 component 3526 and exchanges signal data with a “CTR 0” 3528. In some implementations of the data acquisition circuit 3500, the controller chip 3504 includes a 16-bit counter/timer 3530 that receives signal data from a +100 component 3532 and exchanges signal data with a “CTR 1” 3528. The 24-bit counter/timer 3524, the +10 component 3526, the 16-bit counter/timer 3530 and the +100 component 3532 all receive signal data from an oscillator (OSC) 3536.

In some implementations of the data acquisition circuit 3500, the controller chip 3504 includes a digital input/output (I/O) component 3538 that sends digital signal data to “port C” 3540, “port B” 3542 and “port A” 3544.

In some implementations of the data acquisition circuit 3500, the controller logic 3508 sends signal data to the bus 3502 via a control line 3546 and an interrupt line 3548. In some implementations of the data acquisition circuit 3500, the controller logic 3508 exchanges signal data to the bus 3502 via a transceiver 3550. In some implementations of the data acquisition circuit 3500, the bus supplies +5 volts of electricity to a DC-to-DC converter 3552, that in turn supplies +15V and −15V of electricity.

Some implementations of the data acquisition circuit 3500 include 4 12-bit D/A channels, 24 programmable digital I/O lines, and two programmable counter/timers. Placement of the analog circuitry away from the high-speed digital logic ensures low-noise performance for important applications. Some implementations of the data acquisition circuit 3500 are fully supported by operating systems that can include, but are not limited to, DOS™, Linux™, RTLinux™, QNX™, Windows 98/NT/2000/XP/CE™, Forth™, and VxWorks™ to simplify application development.

FIG. 36 is a block diagram of a hardware and operating environment 3600 in which different implementations can be practiced. The description of FIG. 36 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

Computer 3602 includes a processing unit 3604, commercially available from Intel, Motorola, Cyrix and others. The computer 3602 is one implementation of the predictive analytic control computers in FIG. 3-9. The computer 3602 also includes system memory 3606 that includes random-access memory RAM 3608 and read-only memory ROM 3610. The computer 3602 also includes one or more mass storage devices 3612; and a system bus 3614 that operatively couples various system components to the processing unit 3604. The RAM 3608 and ROM 3610, and mass storage devices 3612, are types of computer-accessible media. Mass storage devices 3612 are more specifically types of nonvolatile computer-accessible media and can include one or more hard disk drives, floppy disk drives, optical disk drives, and tape cartridge drives. The processing unit 3604 executes computer programs stored on the computer-accessible media.

Computer 3602 can be communicatively connected to the Internet 3616 via a communication device, such as modem 3618. Internet 3616 connectivity is well known within the art. In one implementation, the modem 3618 responds to communication drivers to connect to the Internet 3616 via what is known in the art as a “dial-up connection.” In another implementation, the communication device is an Ethernet® or network adapter 3620 connected to a local-area network (LAN) 3622 that itself is connected to the Internet 3616 via what is known in the art as a “direct connection” (e.g., T1 line, etc.).

A user enters commands and information into the computer 3602 through input devices such as a keyboard (not shown) or a pointing device (not shown). The keyboard permits entry of textual information into computer 3602, as known within the art, and implementations are not limited to any particular type of keyboard. Pointing device permits the control of the screen pointer provided by a graphical user interface (GUI) of operating systems such as versions of Microsoft Windows®. Implementations are not limited to any particular pointing device. Such pointing devices include mice, touch pads, trackballs, remote controls and point sticks. Other input devices (not shown) can include a microphone, joystick, game pad, satellite dish, scanner, or the like.

In some implementations, computer 3602 is operatively coupled to a display device 3624. Display device 3624 is connected to the system bus 3614 through a video adapter 3626. Display device 3624 permits the display of information, including computer, video and other information, for viewing by a user of the computer. Implementations are not limited to any particular display device 3624. Such display devices include cathode ray tube (CRT) displays (monitors), as well as flat panel displays such as liquid crystal displays (LCD's). In addition to a monitor, computers typically include other peripheral input/output devices such as printers (not shown). Speakers (not shown) provide audio output of signals. Speakers are also connected to the system bus 3614.

Computer 3602 can be operated using at least one operating system to provide a graphical user interface (GUI) including a user-controllable pointer. Computer 3602 can have at least one web browser application program executing within at least one operating system, to permit users of computer 3602 to access intranet or Internet world-wide-web pages as addressed by Universal Resource Locator (URL) addresses. Examples of browser application programs include Netscape Navigator® and Microsoft Internet Explorer®.

The computer 3602 can operate in a networked environment using logical connections to one or more remote computers, such as remote computer 3628. These logical connections are achieved by a communication device coupled to, or a part of, the computer 3602. Implementations are not limited to a particular type of communications device. The remote computer 3628 can be another computer, a server, a router, a network PC, a client, a peer device or other common network node. The logical connections depicted in FIG. 36 include the local-area network (LAN) 3622 and a wide-area network (WAN). Such networking environments are commonplace in offices, enterprise-wide computer networks, intranets and the Internet.

When used in a LAN-networking environment, the computer 3602 and remote computer 3628 are connected to the local network 3622 through network interfaces or adapters 3620, which is one type of communications device 3618. When used in a conventional WAN-networking environment, the computer 3602 and remote computer 3628 communicate with a WAN through modems. The modems, which can be internal or external, is connected to the system bus 3614. In a networked environment, program modules depicted relative to the computer 3602, or portions thereof, can be stored in the remote computer 3628.

Computer 3602 also includes an operating system 3630 that can be stored on the RAM 3608 and ROM 3610, and/or mass storage device 3612, and is and executed by the processing unit 3604. Examples of operating systems include Microsoft Windows®, Apple MacOS®, Linux®, UNIX®, providing capability for supporting application programs 3632 using, for example, code modules written in the C++® computer programming language. Examples are not limited to any particular operating system, however, and the construction and use of such operating systems are well known within the art.

Instructions can be stored via the mass storage devices 3612 or system memory 3606, including one or more application programs 3632, other program modules 3634 and program data 3636.

Computer 3602 also includes power supply. Each power supply can be a battery. Some implementations include computer instructions that can be stored via the mass storage devices 3612 or system memory 3606 in FIG. 36.

FIG. 37 is a block diagram of a predictive analytic control mobile device 3700, according to an implementation. The predictive analytic control mobile device 3700 includes a number of components such as a main processor 3702 that controls the overall operation of the predictive analytic control mobile device 3700. Communication functions, including data and voice communications, are performed through a communication subsystem 3704. The communication subsystem 3704 receives messages from and sends messages to a wireless network 3706. In this exemplary implementation of the predictive analytic control mobile device 3700, the communication subsystem 3704 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 3704 with the wireless network 3706 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 3706 associated with predictive analytic control mobile device 3700 is a GSM/GPRS, 3G, 4G, 5G and/or 6G wireless network in one exemplary implementation, other wireless networks may also be associated with the predictive analytic control mobile device 3700 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 3702 also interacts with additional subsystems such as a Random Access Memory (RAM) 3708, a flash memory 3710, a display 3712, an auxiliary input/output (I/O) subsystem 3714, a data port 3716, a keyboard 3718, a speaker 3720, a microphone 3722, short-range communications 3724 and other device subsystems 3726.

Some of the subsystems of the predictive analytic control mobile device 3700 perform communication-related functions, whereas other subsystems may provide “resident” or on-device functions. By way of example, the display 3712 and the keyboard 3718 may be used for both communication-related functions, such as entering a text message for transmission over the wireless network 3706, and device-resident functions such as a calculator or task list.

The predictive analytic control mobile device 3700 can send and receive communication signals over the wireless network 3706 after required network registration or activation procedures have been completed. Network access is associated with a subscriber or user of the predictive analytic control mobile device 3700. To identify a subscriber, the predictive analytic control mobile device 3700 requires a SIM/RUIM card 3728 (i.e. Subscriber Identity Module or a Removable User Identity Module) to be inserted into a SIM/RUIM interface 3730 in order to communicate with a network. The SIM card or RUIM 3728 is one type of a conventional “smart card” that can be used to identify a subscriber of the predictive analytic control mobile device 3700 and to personalize the predictive analytic control mobile device 3700, among other things. Without the SIM card 3728, the predictive analytic control mobile device 3700 is not fully operational for communication with the wireless network 3706. By inserting the SIM/RUIM card 3728 into the SIM/RUIM interface 3730, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM/RUIM card 3728 includes a processor and memory for storing information. Once the SIM/RUIM card 3728 is inserted into the SIM/RUIM interface 3730, it is coupled to the main processor 3702. In order to identify the subscriber, the SIM/RUIM card 3728 can include some user parameters such as an International Mobile Subscriber Identity (IMSI). An advantage of using the SIM/RUIM card 3728 is that a subscriber is not necessarily bound by any single physical mobile device. The SIM/RUIM card 3728 may store additional subscriber information for a mobile device as well, including datebook (or calendar) information and recent call information. Alternatively, user identification information can also be programmed into the flash memory 3710.

The predictive analytic control mobile device 3700 is a battery-powered device and includes a battery interface 3732 for receiving one or more rechargeable batteries 3734. In one or more implementations, the battery 3734 can be a smart battery with an embedded microprocessor. The battery interface 3732 is coupled to a regulator 3736, which assists the battery 3734 in providing power V+ to the predictive analytic control mobile device 3700. Although current technology makes use of a battery, future technologies such as micro fuel cells may provide the power to the predictive analytic control mobile device 3700.

The predictive analytic control mobile device 3700 also includes an operating system 3738 and modules 3740 to 3752 which are described in more detail below. The operating system 3738 and the modules 3740 to 3752 that are executed by the main processor 3702 are typically stored in a persistent store such as the flash memory 3710, which may alternatively be a read-only memory (ROM) or similar storage element (not shown). Those skilled in the art will appreciate that portions of the operating system 3738 and the modules 3740 to 3752, such as specific device applications, or parts thereof, may be temporarily loaded into a volatile store such as the RAM 3708. Other modules can also be included.

The subset of modules 3740 to 3752 that control basic device operations, including data and voice communication applications, will normally be installed on the predictive analytic control mobile device 3700 during its manufacture. Other modules include a message application 3742 that can be any suitable software program that allows a user of the predictive analytic control mobile device 3700 to send and receive electronic messages. Various alternatives exist for the message application 3742 as is well known to those skilled in the art. Messages that have been sent or received by the user are typically stored in the flash memory 3710 of the predictive analytic control mobile device 3700 or some other suitable storage element in the predictive analytic control mobile device 3700. In one or more implementations, some of the sent and received messages may be stored remotely from the predictive analytic control mobile device 3700 such as in a data store of an associated host system with which the predictive analytic control mobile device 3700 communicates.

The modules can further include a device state module 3744, a Personal Information Manager (PIM) 3746, and other suitable modules (not shown). The device state module 3744 provides persistence, i.e. the device state module 3744 ensures that important device data is stored in persistent memory, such as the flash memory 3710, so that the data is not lost when the predictive analytic control mobile device 3700 is turned off or loses power.

The PIM 3746 includes functionality for organizing and managing data items of interest to the user, such as, but not limited to, e-mail, contacts, calendar events, voice mails, appointments, and task items. A PIM application has the ability to send and receive data items via the wireless network 3706. PIM data items may be seamlessly integrated, synchronized, and updated via the wireless network 3706 with the mobile device subscriber's corresponding data items stored and/or associated with a host computer system. This functionality creates a mirrored host computer on the predictive analytic control mobile device 3700 with respect to such items. This can be particularly advantageous when the host computer system is the mobile device subscriber's office computer system.

The predictive analytic control mobile device 3700 also includes a connect module 3748, and an IT policy module 3750. The connect module 3748 implements the communication protocols that are required for the predictive analytic control mobile device 3700 to communicate with the wireless infrastructure and any host system, such as an enterprise system, with which the predictive analytic control mobile device 3700 is authorized to interface.

The connect module 3748 includes a set of APIs that can be integrated with the predictive analytic control mobile device 3700 to allow the predictive analytic control mobile device 3700 to use any number of services associated with the enterprise system. The connect module 3748 allows the predictive analytic control mobile device 3700 to establish an end-to-end secure, authenticated communication pipe with the host system. A subset of applications for which access is provided by the connect module 3748 can be used to pass IT policy commands from the host system to the predictive analytic control mobile device 3700. This can be done in a wireless or wired manner. These instructions can then be passed to the IT policy module 3750 to modify the configuration of the predictive analytic control mobile device 3700. Alternatively, in some cases, the IT policy update can also be done over a wired connection.

The IT policy module 3750 receives IT policy data that encodes the IT policy. The IT policy module 3750 then ensures that the IT policy data is authenticated by the predictive analytic control mobile device 3700. The IT policy data can then be stored in the flash memory 3710 in its native form. After the IT policy data is stored, a global notification can be sent by the IT policy module 3750 to all of the applications residing on the predictive analytic control mobile device 3700. Applications for which the IT policy may be applicable then respond by reading the IT policy data to look for IT policy rules that are applicable.

The IT policy module 3750 can include a parser 3752, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 3750 can determine which applications are affected by the IT policy data and send a notification to only those applications. In either of these cases, for applications that are not being executed by the main processor 3702 at the time of the notification, the applications can call the parser or the IT policy module 3750 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string. Therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 3750 sends an acknowledgement back to the host system to indicate that the IT policy data was received and successfully applied.

Other types of modules can also be installed on the predictive analytic control mobile device 3700. These modules can be third party applications, which are added after the manufacture of the predictive analytic control mobile device 3700. Examples of third party applications include games, calculators, utilities, etc.

The additional applications can be loaded onto the predictive analytic control mobile device 3700 through at least one of the wireless network 3706, the auxiliary I/O subsystem 3714, the data port 3716, the short-range communications subsystem 3724, or any other suitable device subsystem. This flexibility in application installation increases the functionality of the predictive analytic control mobile device 3700 and may provide enhanced on-device functions, communication-related functions, or both. For example, secure communication applications may enable electronic commerce functions and other such financial transactions to be performed using the predictive analytic control mobile device 3700.

The data port 3716 enables a subscriber to set preferences through an external device or software application and extends the capabilities of the predictive analytic control mobile device 3700 by providing for information or software downloads to the predictive analytic control mobile device 3700 other than through a wireless communication network. The alternate download path may, for example, be used to load an encryption key onto the predictive analytic control mobile device 3700 through a direct and thus reliable and trusted connection to provide secure device communication.

The data port 3716 can be any suitable port that enables data communication between the predictive analytic control mobile device 3700 and another computing device. The data port 3716 can be a serial or a parallel port. In some instances, the data port 3716 can be a USB port that includes data lines for data transfer and a supply line that can provide a charging current to charge the battery 3734 of the predictive analytic control mobile device 3700.

The short-range communications subsystem 3724 provides for communication between the predictive analytic control mobile device 3700 and different systems or devices, without the use of the wireless network 3706. For example, the subsystem 3724 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 3704 and input to the main processor 3702. The main processor 3702 will then process the received signal for output to the display 3712 or alternatively to the auxiliary I/O subsystem 3714. A subscriber may also compose data items, such as e-mail messages, for example, using the keyboard 3718 in conjunction with the display 3712 and possibly the auxiliary I/O subsystem 3714. The auxiliary subsystem 3714 may include devices such as: a touch screen, mouse, track ball, infrared fingerprint detector, or a roller wheel with dynamic button pressing capability. The keyboard 3718 is preferably an alphanumeric keyboard and/or telephone-type keypad. However, other types of keyboards may also be used. A composed item may be transmitted over the wireless network 3706 through the communication subsystem 3704.

For voice communications, the overall operation of the predictive analytic control mobile device 3700 is substantially similar, except that the received signals are output to the speaker 3720, and signals for transmission are generated by the microphone 3722. Alternative voice or audio I/O subsystems, such as a voice message recording subsystem, can also be implemented on the predictive analytic control mobile device 3700. Although voice or audio signal output is accomplished primarily through the speaker 3720, the display 3712 can also be used to provide additional information such as the identity of a calling party, duration of a voice call, or other voice call related information.

In some implementations, the predictive analytic control mobile device 3700 includes a camera 3754 receiving a plurality of images 3756 from and examining pixel-values of the plurality of images 3756.

### CONCLUSION

Systems, methods and apparatus that is operable to perform machine learning predictive analytics is described. A technical effect of the system to perform machine learning predictive analytics is to generate a prediction of expected actions based on contributions of resources and interests of the particular entities. Although specific implementations are illustrated and described herein, it will be appreciated by those of ordinary skill in the art that any arrangement which is calculated to achieve the same purpose may be substituted for the specific implementations shown. This application is intended to cover any adaptations or variations. For example, although described in machine learning terms, one of ordinary skill in the art will appreciate that implementations can be made in data mining technologies or any other relationship that provides the required function.

Examples of the parameter 140 in FIG. 1-3, the item 410 in FIG. 4, the item 510 in FIG. 5, the item 610 in FIG. 6, the item 710 in FIG. 7, the item 810 in FIG. 8, the item 910 in FIG. 9 and the keyword in FIG. 26-28 include a noise word, a code, a codeword.

Examples of the Representations of issues of interest include a topic, a subject, a concern, a consequence, a dispute, an event, a situation, a controversy or a perception.

Examples of the contributions of resources include computer hardware, computer software, computing cycles, computing timesharing time, data storage, automobiles, construction materials, money or cryptocurrency. In some implementations, the contributions of resources in FIG. 1-18 are volunteer work or donations of goods.

Examples of the features include at least one of an identifier (SSN or EIN) of the entity, a name of the entity, a net worth of the entity, an age of the entity, a gender of the entity, a work title of the entity, an industry of the entity, and a location zip code.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future machine learning processes, different machine learning models and new profile data.

The terminology used in this application meant to include all entities, features, machine learning processes and data mining technologies which provide the same functionality as described herein.

1. A method of machine learning predictive analytics, the method performed by a predictive analytic control computer and comprising:
receiving from a second computer a plurality of training profile data that describes one or more contributions of resources that are associated and identified with particular entities;
receiving from a third computer a plurality of training profile data that are associated and identified with the particular entities, that does not describe one or more contributions of resources the training profile data, and that includes data that is that is received from additional computers that host websites and applications that focus on communication, community-based input, interaction, content-sharing and collaboration that describe features and representations of issues of interest of the particular entities;
generating a machine learning predictive analytic model by a machine learning predictive analytic trainer in reference to the training profile data;
generating a plurality of predictions by a machine learning predictive analytic engine from the machine learning predictive analytic model and new data; and
transmitting the plurality of predictions to a memory.

2. (canceled)

3. (canceled)

4. A method of claim 1, wherein the generating the plurality of the training profile data by the machine learning predictive analytic engine in reference to the new data further comprises:
generating the plurality of the training profile data by the machine learning predictive analytic engine in reference to only data.

5. A method of claim 1, wherein the new data further comprises text new data.

6. A method of claim 1, wherein the training profile data further comprises text training profile data.

7. (canceled)

8. (canceled)

9. (canceled)

10. (canceled)

11. (canceled)

12. (canceled)

13. A method of claim 1, wherein the machine learning predictive analytic engine further comprises computer instructions that when executed perform:
a machine learning linear K-means process.

14. A method of claim 1, wherein the machine learning predictive analytic engine further comprises computer instructions that when executed perform:
a machine learning random forest process.

15. A method of claim 1, wherein the machine learning predictive analytic engine further comprises computer instructions that when executed perform:
a machine learning dimensionality reduction process.

16. A method of claim 1, wherein the machine learning predictive analytic engine further comprises computer instructions that when executed perform:
a machine learning gradient boosting process.

17. A method of claim 1, wherein the machine learning predictive analytic engine further comprises computer instructions that when executed perform:
a machine learning ADA boosting process.

18. (canceled)

19. (canceled)

20. (canceled)

21. (canceled)

22. A method of claim 1, further comprising:
transmitting the plurality of predictions from the memory to the second computer.

23-36. (canceled)

37. A method of machine learning predictive analytics to determine a magnitude of a contribution of resources by an entity in reference to a keyword, the method performed by a microprocessor in a predictive analytic control computer and the method comprising:
determining a quantitative measure of a strength of a relationship between the keyword and a first training profile data for the entity, the determining being performed by a machine learning predictive analytic engine in reference to a machine learning predictive analytic model that is trained on the first training profile data, the first training profile data being associated with a plurality of unique entities, the first training profile data describing a community-based input, interaction, content-sharing and collaboration that describes features and representations of issues of interest of the entity, wherein a portion of the first training profile data being associated with the entity; and
determining the magnitude of the contribution of the resources by the entity in reference to the quantitative measure and a second training profile data, the second training profile data describing one or more contributions of the resources that are associated and identified with the entity.

38. (canceled)

39. The method of claim 37, wherein the keyword is text data.

40-45. (canceled)

46. The method of claim 37, wherein the machine learning predictive analytic engine further comprises computer instructions that when executed perform:
a machine learning linear K-means process.

47. The method of claim 37, wherein the machine learning predictive analytic engine further comprises computer instructions that when executed perform:
a machine learning random forest process.

48. The method of claim 37, wherein the machine learning predictive analytic engine further comprises computer instructions that when executed perform:
a machine learning dimensionality reduction process.

49. The method of claim 37, wherein the machine learning predictive analytic engine further comprises computer instructions that when executed perform:
a machine learning gradient boosting process.

50. The method of claim 37, wherein the machine learning predictive analytic engine further comprises computer instructions that when executed perform:
a machine learning ADA boosting process.

51. The method of claim 37, further comprising:
receiving the second training profile data from a second computer.

52. The method of claim 51, further comprising:
receiving the first training profile data from a third computer.

53-59. (canceled)
